(19) United States
(12) Patent Application Publication
(10) Pub. No.: US 2025/0289076 A1
(43) Pub. Date: Sep. 18, 2025

(54) MATERIAL PROCESSING SYSTEM

(71) Applicant: Mikkelsen Innovation ApS, Knebel (DK)

(72) Inventors: Steen B. Mikkelsen, Knebel (DK); Rasmus Hedeager Mikkelsen, Aarhus C (DK); Nikolai Steen Mikkelsen, Milwaukee, WI (US); William A. Dalzell, Milwaukee, WI (US)

(73) Assignee: Mikkelsen Innovation ApS, Knebel (DK)

(21) Appl. No.: 19/224,044

(22) Filed: May 30, 2025

Related U.S. Application Data
(63) Continuation-in-part of application No. PCT/IB2023/062145, filed on Dec. 1, 2023.
(60) Provisional application No. 63/429,771, filed on Dec. 2, 2022.

(51) Int. Cl. B23K 26/08; B23K 26/38; B29C 65/00; B29C 65/08; B29C 65/78

(52) U.S. Cl. CPC B23K 26/0876; B23K 26/0838; B23K 26/38; B29C 65/08; B29C 65/787; B29C 66/0246; B29C 66/729; B29C 66/845

(57) ABSTRACT

An automated material processing system includes a frame having a longitudinal axis and a gantry movable along the longitudinal axis of the frame; a first belt extending along the longitudinal axis and moving about a cavity having a cavity opening within the gantry. A second belt supported by the gantry extends across the frame in a cross-frame direction perpendicular to the longitudinal axis and covering at least a portion of the cavity opening. A material treatment system to treat a material extends across at least a portion of the first belt and a portion of the second belt, and a vacuum system movable with the gantry and operatively connected to a manifold adjacent to both sides of the cavity opening.

### CROSS-REFERENCE TO RELATED PATENT APPLICATIONS

This application is a Continuation-in-Part of International Application No. PCT/IB2023/062145 filed Dec. 1, 2023, entitled Material Processing System, which claims the benefit of U.S. Provisional Application No. 63/429,771 filed Dec. 2, 2022, entitled Material Joining and Cutting System, both of which are incorporated herein in their entireties.

### BACKGROUND

The present invention relates to the field of automated material joining systems and more specifically to an automated system that includes both joining and cutting of materials.

### SUMMARY

In some aspects, the techniques described herein relate to an automated material processing system including: a frame having a longitudinal axis; a gantry movable along the longitudinal axis of the frame; a first belt extending along the longitudinal axis and moving about a cavity having a cavity opening within the gantry; a second belt supported by the gantry extending across the frame in a cross-frame direction perpendicular to the longitudinal axis and covering at least a portion of the cavity opening; a material treatment system to treat a material extending across at least a portion of the first belt and a portion of the second belt; and a vacuum system movable with the gantry and operatively connected to a manifold adjacent to both sides of the cavity opening.

In some aspects, the techniques described herein relate to an automated system for joining and cutting flexible materials including: a frame having a longitudinal axis; a gantry movable along the longitudinal axis; a belt system extending along the longitudinal axis and moving through a cavity within the gantry; a joining system supported by the gantry and movable along a cross-frame axis perpendicular to the longitudinal axis to join at least two materials together; a cutting system supported by the gantry and movable along the cross-frame axis to cut the material together in more than one direction within a plane defined by the longitudinal axis and the cross-frame axis a vacuum system movable with the gantry and operatively connected to a manifold on both sides of the cavity opening.

In some aspects, the techniques described herein relate to an automated system for joining and cutting flexible materials including: a frame having a longitudinal axis; a gantry movable along the longitudinal axis; a vacuum system having a duct movable with and along a cross-frame axis perpendicular to the longitudinal axis of the gantry; a belt system extending along the longitudinal axis and moving through a cavity within the gantry; and a material treatment system movably supported by and along the gantry configured to treat a material supported by the belt system.

### BRIEF DESCRIPTION OF THE DRAWINGS

FIG. 1 is an isometric view of an automated material joining system.

FIG. 2 is a partial side view of the system of FIG. 1.

FIG. 3 is a side perspective view of a joining system within the gantry.

FIG. 4 is an isometric view of the gantry.

FIG. 5A is a cross-sectional side view of the gantry.

FIG. 5B is a cross-sectional side view of the gantry in one implementation.

FIG. 5C is a schematic view of a cross belt path within the gantry cavity.

FIG. 6 is a close-up view of the cross belt.

FIG. 7 is a perspective top side view of the manifold and guide plate.

FIG. 8 is a side view of a guide plate.

FIG. 9 is a side perspective view of the joining system.

FIG. 10 a bottom perspective view of the vacuum system.

FIG. 11 is a partial side view of the system of FIG. 2 with the gantry in a second location.

FIG. 12 is a view of materials being loaded onto the system.

FIG. 13 is a view of materials after being joined and cut.

FIG. 14 is a schematic view of a creasing module.

FIG. 15 is a schematic view of a grommet Insertion module.

FIG. 16 is a schematic view of a metal snap insertion module.

FIG. 17 is a schematic view of a CNC routing module.

FIG. 18A, FIG. 18B, FIG. 18C and FIG. 18D are schematic views of a blade cutting module.

FIG. 19 is a schematic view of an embossing module.

FIG. 20 is a schematic view of a printing module.

FIG. 21 is a schematic view of an ultrasonic bonding module.

FIG. 22 is a schematic view of laser dump device with sensor

FIG. 23 is a schematic view of a laser feedback control system.

FIG. 24 is an isometric view of the gantry in one implementation.

FIG. 25 is an isometric view of a vacuum cassette.

FIG. 26 is a cross sectional view of opposing vacuum cassettes forming the gantry cavity.

FIG. 27 is an isometric view of vacuum cassettes on a portion of the gantry.

FIG. 28 is an isometric view of a portion of the vacuum cassette system of FIG. 27.

FIG. 29 is a cross sectional view of the vacuum cassette system of FIG. 28.

FIG. 30A is an isometric view of one cassette of FIG. 27.

FIG. 30B is a close up view of a portion of the cassette of FIG. 30A.

FIG. 30C is an exploded view of the cassette of FIG. 30A.

FIG. 31 is an isometric exploded view of the vacuum tube and vacuum actuator.

FIG. 32A is a cross sectional view of the vacuum actuator in an open position.

FIG. 32B is a cross sectional view of the vacuum actuator in a closed position.

### DETAILED DESCRIPTION OF THE EXAMPLE EMBODIMENTS

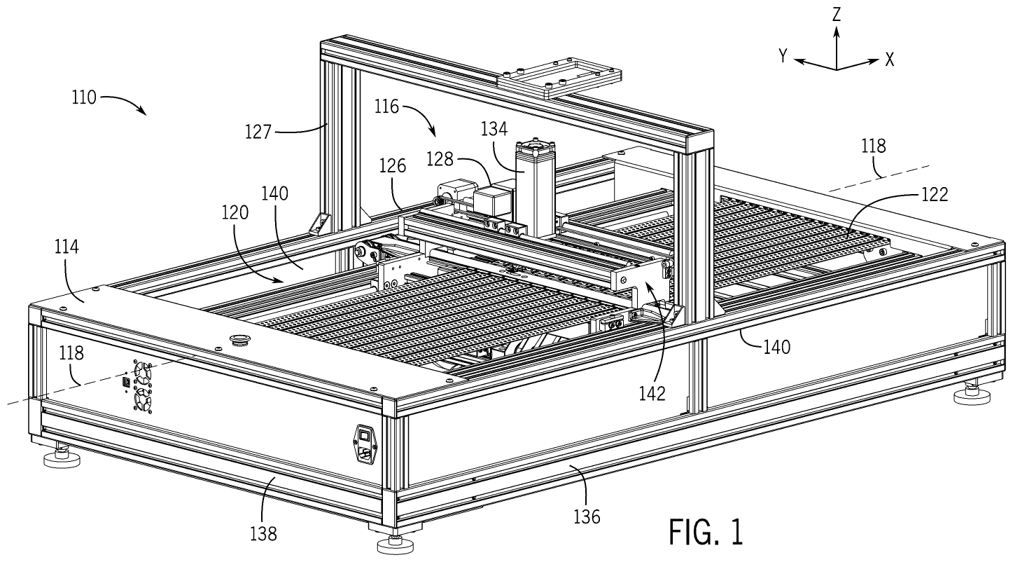

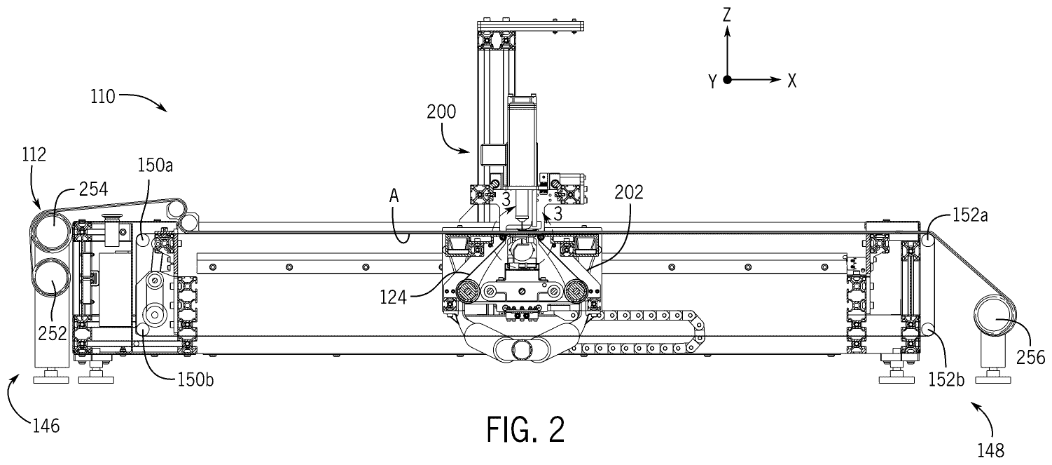

Referring to FIG. 1 and FIG. 2 an automated material joining and cutting system 110 (system 110) for joining materials 112. System 110 includes a frame 114 supporting a gantry 116 movable along a longitudinal axis 118 of frame 114. A belt system 120 includes a first longitudinal belt system 122. In one implementation belt system 120 further includes a horizontal belt 126 system within gantry 116 that extends perpendicular to longitudinal axis 118 and first longitudinal belt system 122. In one implementation longitudinal belt system 122 includes a plurality of individual belts 124 that are separated from extend parallel to one another. As described herein below, individual belts 124 are selectively movable relative to frame 114 and gantry 116. In one implementation system 110 has the same features as described in pending PCT Application No. PCT/EP2022/064663 (“663 application”) entitled Automated Sewing System and being incorporated herein in its entirety. The '663 application is attached hereto as Appendix A and is part of the specification.

In one implementation system 110 includes a joining system 128 that is movably supported by gantry 116 for joining materials 112. In one implementation joining system 128 includes a sewing system 130 that joins materials 112 together by sewing. In one implementation a vision system may be supported by an arch member 127 that is stationary with respect to frame 114. In one implementation arch member 127 moves with gantry 116.

In one implementation system 110 includes a cutting system 134 that cuts materials 112. In one implementation, joining system 128 and cutting system 134 are both secured to gantry 116 at the same time allowing system 110 to both join materials 112 and cut materials 112 while materials 112 on the same system without the need to change joining system 128 with cutting system 134. In one implementation a joining head of joining system 128 and a cutting head of cutting system 134 are mounted to gantry 116 next to each other and automatically moved into an operating position by a controller.

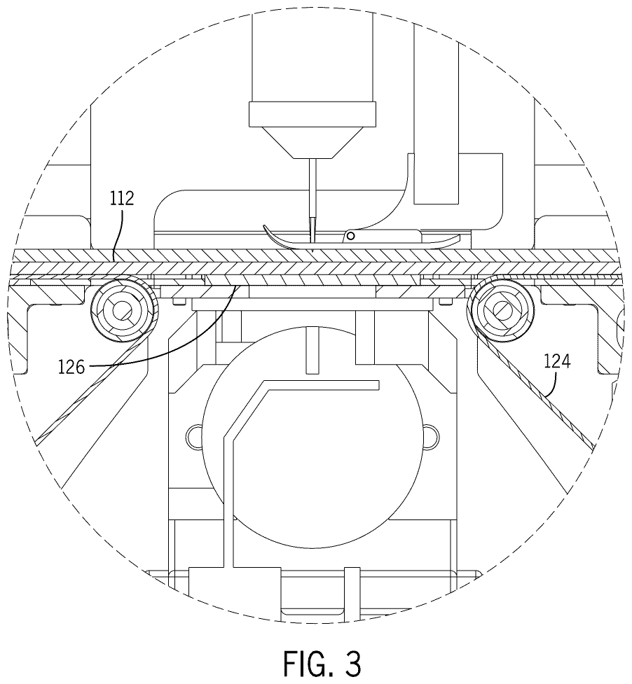

Referring to FIGS. 1-3, frame 114 includes a chassis including longitudinal members 136 extending parallel to longitudinal axis 118 and cross members 138 extending perpendicular to longitudinal members 136 and parallel to one another. A pair of longitudinal gantry support members 140 support gantry 116 for movement along longitudinal axis 118. Gantry includes a cross member 142 that supports joining system 128 and cutting system 134 for movement in the cross frame direction which is perpendicular to longitudinal axis 118. In one implementation gantry 116 is moved longitudinally along longitudinal gantry support members 140 with a motor 144 that moves gantry 116 between a first longitudinal end 146 and a second longitudinal end 148. Systems for moving a gantry on frame are known in the art and may include a single lead screw or a double lead screw and stepper motors that may be controlled by a controller. Similarly, joining system 128 and cutting system 134 are moved along cross member 142 in a direction perpendicular to longitudinal axis 118 by a motor that is controlled by a controller.

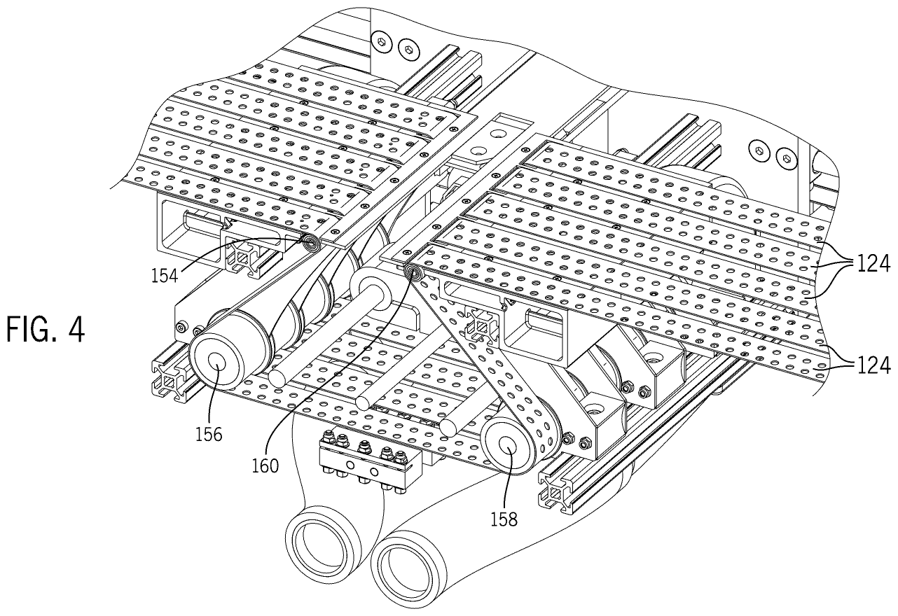

Referring to FIG. 1 and FIG. 4 first longitudinal belt system 122 includes individual belts 124 that form a belt path. In one implementation belt system 122 includes a single belt extending substantially along the entire width (along the Y-axis) of frame 114. The belt path is defined by gantry 116, and a first set of proximal cross bars 150a, 150b proximate first longitudinal end 146 and a second set of distal cross bars 152a, 152b proximate second longitudinal end 148. Gantry 116 includes a first bar 154, a second bar 156, a third bar 158 and a fourth bar 160. Each of the bars, 150a, 150b, 152a, 152b, 154, 156, 158, and 160 extend in a cross system direction along the Y axis as shown in FIG. 1 and perpendicular to longitudinal axis 118. Note that the term along the Y axis will refer to an axis that is co-axial with a Y axis and parallel to a Y axis in the X-Y plane. Belt 124 extends over cross bar 150a to gantry 116 then over first bar 154 along or parallel to longitudinal axis 118 then extends in a downward and rearward direction toward and about second bar 156. Belt 124 then extends forward toward and about third bar 158 and then rearward and upward and about fourth bar 160. Belt 124 then extends toward and over upper distal cross bar 152a and then extends rearward toward and about lower distal cross bar 152b. Belt 124 then extends forward toward and over lower proximal cross bar 150b. The term upward as used herein refers to the positive Z axis and the term downward refers to the negative Z axis. Similarly, the term rearward refers to the negative X direction and the term forward refers to the positive X direction. Angle support brackets 151 and 153 extend from lower support bars 150b and 152b respectively. Brackets 151, 153 support Manifold 168. Referring to FIG. 2, the positive X direction extends from a loading side of system 110 toward the unloading side of system 110. Stated another way the material being processed moves generally is loaded from first longitudinal end 146 and unloaded at second longitudinal end 148.

In one implementation each of the bars 154, 156, 158, and 160 rotate along their entire longitudinal axis about a bearing. One of bars 154, 156, 158, and 160 is a driven bar by a motor to drive belt 124 about the belt path. In one implementation more than one bar is a driven bar to drive belts 124 about the belt path synchronously, such that each belt 124 moves uniformly in the same direction. In implementation, individual rollers are provided on each bar for each belt, such that the individual rollers rotate about one or more of bars 150-160 independently of one another. In one implementation one or more of bars 150-160 and/or separate rollers on the bars do not rotate but rather belt 124 rotates about the bar without the bar or without separate roller rotating about the longitudinal axis of the bar. For example, bars 154 and 158 may have a smooth edge. Note that rollers 154 in one implementation are small (to reduce y belt width), and have a radius of 10 mm. In contrast in one implementation rollers 158 are larger than the rollers 154 and range between 50 mm and 100 mm to create more traction if they are motor driven. The motor drive can also be located at a far end of the frame driving the end rollers.

Belts 124 create a cavity 162 between rollers 154, 156, 158 and 160. The distance in the longitudinal direction between roller 154 and 158 is less than the distance between roller 156 and roller 160. In one implementation cavity 162 has a generally frustum prism shape with a narrow opening 170 and a wider base 172. Stated another way opening of cavity 162 is defined by the space between bar 154 and bar 158 between a first side 164 of gantry 116 and a second side 166 of gantry 116. Note that since gantry 116 moves in the cross system direction cavity 162 moves relative to frame 114.

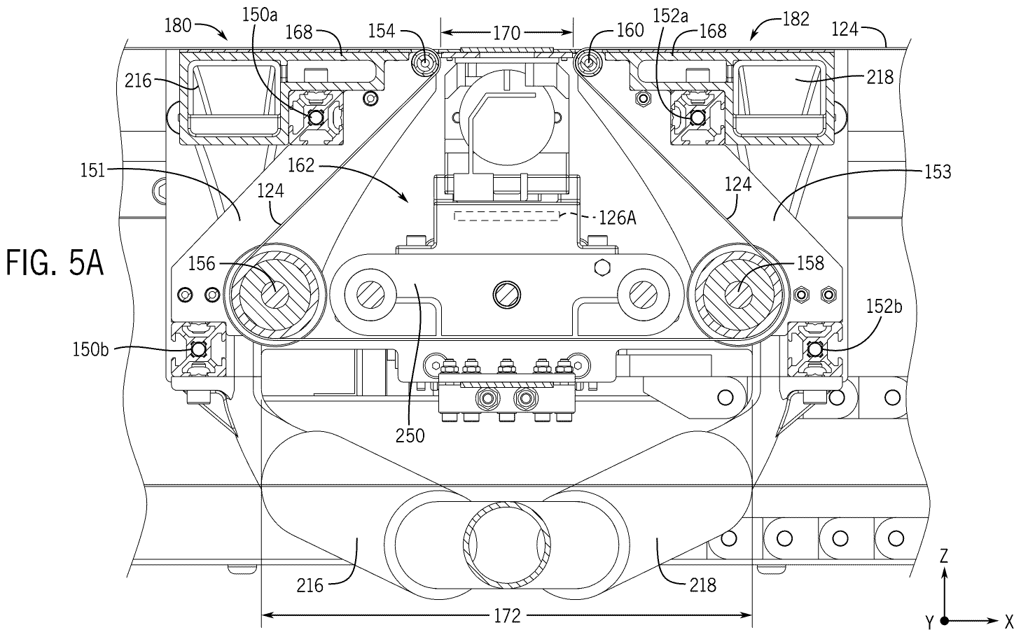

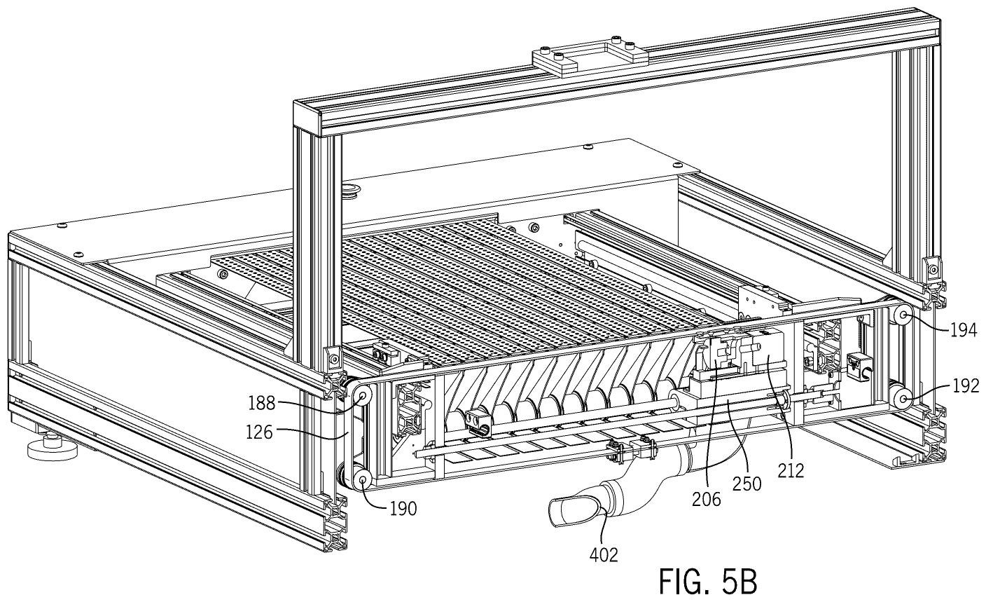

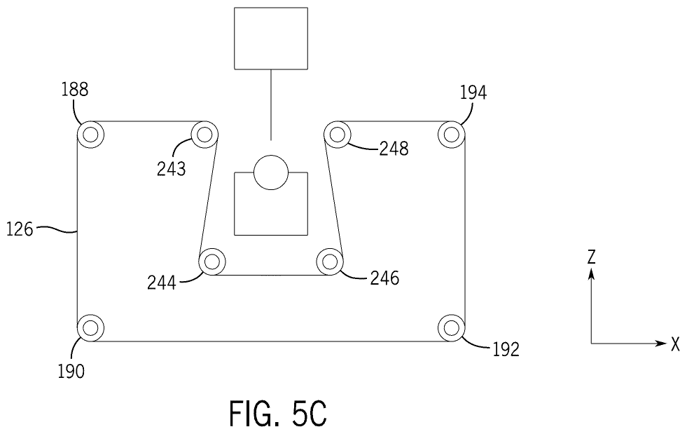

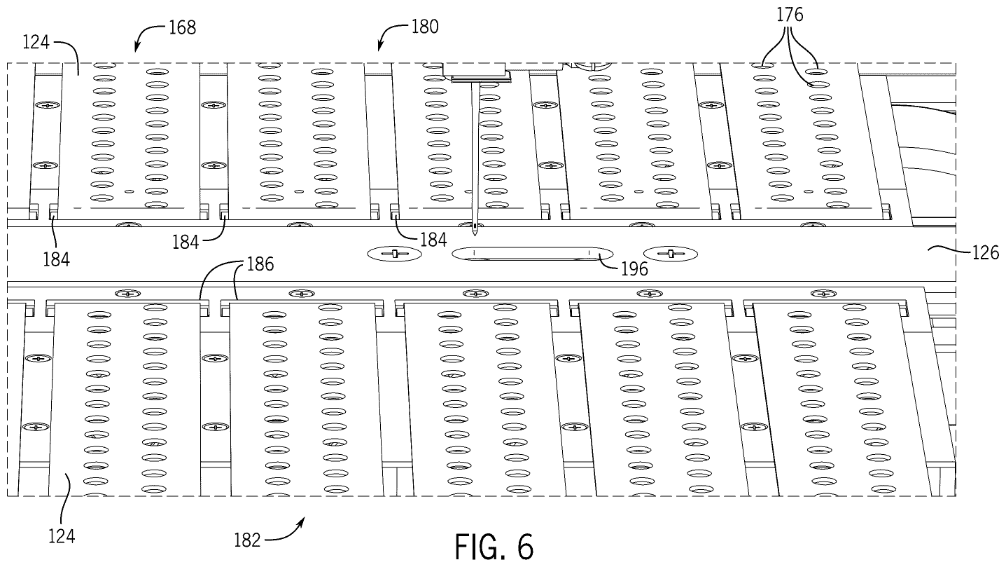

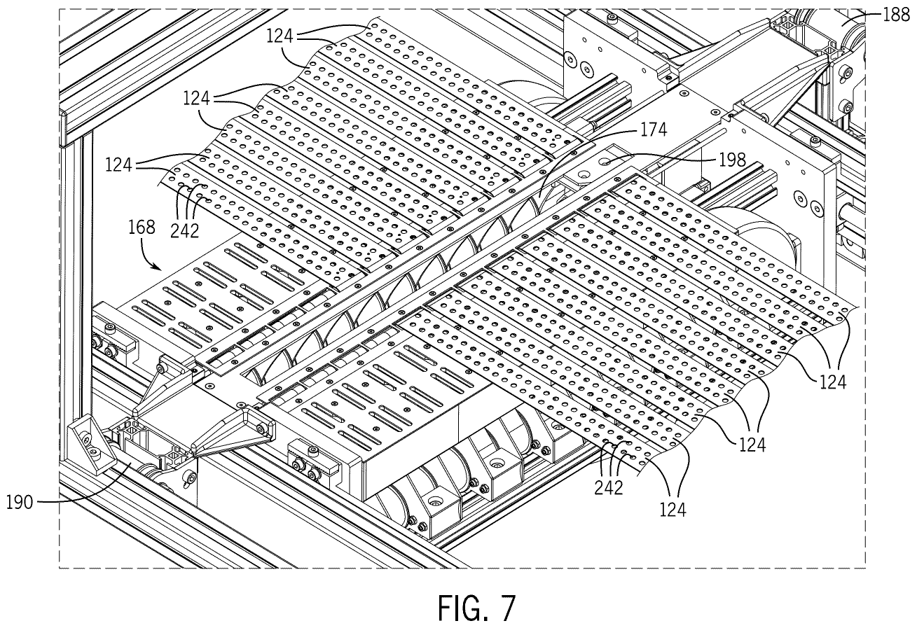

Referring to FIG. 5A, FIG. 6 and FIG. 7, a manifold 168 defines an opening 174 that is adjacent to narrow opening 170 of cavity 162. Opening 174 has a first longitudinal edge and a second longitudinal edge spaced from and parallel to first longitudinal edge and extending in the cross system direction. Manifold 168 has a proximal region 180 and a second distal region 182. Proximal region 180 and second distal region 182 of manifold 168 have a plurality of openings 176 extending therethrough generally aligned with each belt 124. In one implementation proximal region 180 and second distal region 182 are closely adjacent to opening 174 along the longitudinal axis. In one implementation each belt 124 is separated by 5 mm in the Y axis direction. Manifold 168 includes a first set of belt openings 184 adjacent proximal region 180 and a second set of belt openings 186 adjacent second distal region 182. Each belt 124 extends through one of the openings in first belt openings 184 and one of the openings in second belt openings 186. In one implementation manifold 168 does not have openings through which belts 124 extend, but rather belts are guided over a ledge. In one implementation the horizontal belt 126 has a first longitudinal edge end that is closely adjacent to the portions of belts 124 that extend downward into the gantry cavity area and a second longitudinal edge that is closely adjacent to the portion of belts 124 that extend upward from the gantry cavity area. In one implementation the distance between the longitudinal edges of horizontal belt 126 and the portions of belts 124 proximate gantry 116 is 5 mm or less.

Referring to FIG. 2 and FIG. 5C, horizontal belt 126 extends in a cross system direction about a first roller 188, a second roller 190, a third roller 192 and a fourth roller 194. One of rollers 188, 190, 192, and 194 is a drive roller and the other rollers is a driven roller. In one implementation more of rollers 188, 190, 192 and 194 is a drive roller. In one implementation none of rollers 188, 190, 192 and 194 is a drive roller, rather belt 126 is secured to a plate 198 which is automatically driven by a motor. Horizontal belt 126 includes at least one opening 196 allowing a joining member such as a needle to extend therethrough. In one implementation horizontal belt 126 includes more than one opening allowing a separate cutting instrument to extend therethrough including a laser, a knife, or other cutting instruments described herein or known in the art.

Horizontal belt 126 has an outside surface that extends outward and an opposing second surface. As noted above in one implementation plate 198 is secured to horizontal belt 126 and adjacent to the second surface. Plate 198 is rigid and moves in cross-system direction along with horizontal belt 126. In one implementation plate 198 is connected to and moves horizontal belt 126 by a screw actuator or other known drive mechanisms. In one implementation plate 198 and horizontal belt 126 can be moved independently and automatically aligned during a process in which an aperture in horizontal belt 126 and an aperture in plate 198 need to be aligned.

Referring to FIGS. 1, 2 and 7, gantry 116 includes an upper member 200 and a lower housing 202. Joining system 128 includes an upper portion 204 movably supported on upper member 200 of gantry 116 and a lower portion 206 movably supported on lower housing 202. In one implementation joining system 128 is a sewing system 130 and an upper portion 204 includes the needle mechanism and lower portion 206 includes a bobbin. A needle 208 of sewing system 130 extends through opening in horizontal belt 126 and an opening in plate 198. In one implementation the upper and lower members of gantry 116 move along the longitudinal axis 118 (X-axis) and the cross system axis (Y-axis) with high accuracy such as +/−0.1 mm so that the needle and hook will connect the threads and create sewing knots.

Gantry 116 also supports a cutting system 134 having an upper portion 210 and a lower portion 212. Where upper portion 210 is movably supported on upper member 200 of gantry 116 and lower portion 212 is movably supported on lower housing 202. In one implementation horizontal belt 126 includes a second opening through which a cutting member extends between upper portion 210 and lower portion 212 of cutting system 134. In one implementation cutting system 134 is a laser cutting system in which a laser is generated in upper portion 210 and a base member in lower portion 212 to dissipate any laser energy and remove fumes after the materials have been cut. In one implementation cutting system 134 includes a laser system that can cut from both the bottom and the top of materials 112. In this implementation both the upper module and the lower module would include both a laser and a base member.

Referring to FIG. 5A a vacuum system 214 is supported by gantry 116 and includes a vacuum pump operatively connected to a first duct 216 and a second duct 218. In one implementation vacuum system 214 is secured to an outside portion of gantry 116 that is outside of cavity 162. First duct 216 extends from a location below cavity 162 to a position adjacent a lower surface 220 of proximal region 180 of manifold 168. Second duct 218 extends from a location below cavity 162 to a position adjacent a lower surface 222 of second distal region 182 of manifold 168. First duct 216 and second duct 218 include openings facing the openings extending through proximal region 180 and second distal region 182. Vacuum system 214 applies a vacuum to materials 112 being joined and cut adjacent to the opening 170 providing a force to materials 112 to maintain the location of materials 112 as gantry 116 is moved longitudinally within frame 114. Belts 124 glide on top of the vacuum boxes despite any friction created between the lower surface of belt 124 and vacuum box surface-aka printing belts. Belts 124 have low friction backside and top high friction to better grip the materials 112.

In one implementation vacuum system 214 provides a vacuum sufficient to allow materials 112 to be held in a fixed position relative to frame 114 as gantry 116 moves along longitudinal axis 118.

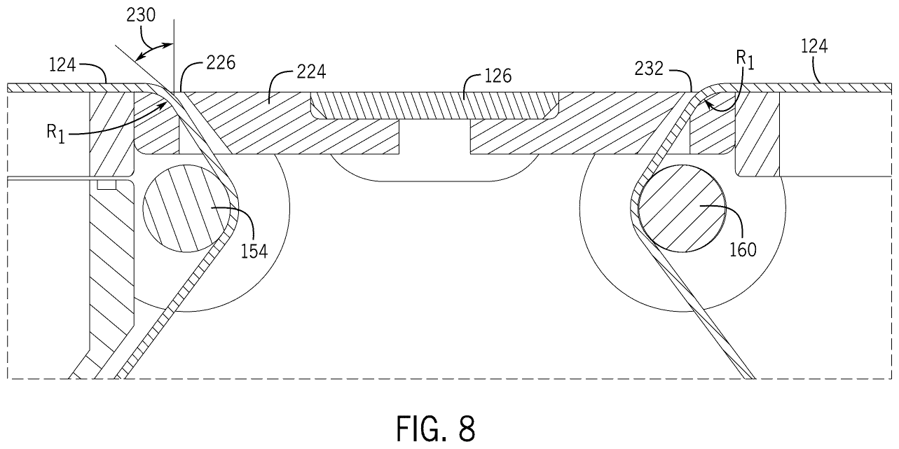

Referring to FIG. 8, in one implementation manifold 168 includes a belt bend plate 224 configured to guide belt 124 into gantry 116 toward bars 154 and 160. Belt bend plate 224 includes a first opening 226 having a radius R1 and a path 228 that guides belt 124 at an angle 230 greater less than 90 degrees toward and away from bar 154. In one implementation the angle 230 is less than 45 degrees. Belt 124 then extends about first bar 154 as belt 124 is directed toward second bar 156. Similarly, belt bend plate 224 includes a second opening 232 that includes a second guide path 234 extending toward away from bar 160, having similar but opposite geometry to the path 228.

In one implementation system 110 includes an internal cavity vacuum system which includes a vacuum pump located outside of gantry 116 and either supported by frame 114 for external to frame 114 that is operatively connected to a hose or duct within gantry 116 that removes gases associated with laser cutting and/or material removed during a cutting process. In one implementation, system 110 includes an air pump (not shown) that includes an air pump located outside of gantry 116 and either supported by frame 114 or external to frame 114 that is operatively connected to a hose or duct within gantry 116 that provides a positive air pressure within gantry 116 where the air escapes through horizontal belt 126 to create a cushion of air on the portion of materials 112 directly over horizontal belt 126. In one implementation the operation of the internal cavity vacuum system and the air pump are controlled by a controller to operate only when needed. Stated another way, internal cavity vacuum system may be automatically operated solely when cutting system 134 is operational. Similarly, the air pump may be automatically operated solely when gantry 116 is moving along longitudinal axis 118. Similarly, vacuum system 214 may be automatically operated solely when gantry 116 is moving along longitudinal axis 118. A controller may operate all three air devices (one vacuum system 214, internal cavity vacuum system, and the air pump) automatically turning each system on and off based upon movement gantry 116 along longitudinal axis 118 and/or operation of cutting system 134.

In one implementation, the air pump operates to provide positive air pressure to lift the portion of materials 112 away from a base of frame 114 along the substantially the entire operational width of frame 114 along which materials 112 extend. In one implementation the air pressure provided is sufficient to minimize friction between horizontal belt 126 and materials 112 as gantry 116 is being moved along the longitudinal axis 118 to avoid buckling or any disruption or unintended movement of the material being processed. In this way positional control of the material being processed is maintained. In one implementation the region in which air pump provides air pressure is limited to the region in which material 112 is present. In one implementation a sensor detects the location of materials 112 proximate horizontal belt 126 and limits the air flow to the region of horizontal belt 126 where materials 112 is present. In one implementation the cavity vacuum system provides a vacuum proximate the cutting system 134 is operating. Stated another way, the cavity vacuum system includes a hose that moves along with cutting system 134 along gantry 116 such that the cavity vacuum system focuses the air and material removal adjacent to the portion of materials 112 being removed as the portion of materials 112 is being removed. In one implementation a single vacuum pump is provided for both the removal of gases and/or materials removed from materials 112 during a cutting operation as well as for providing a vacuum to materials 112 through manifold 168 external to the cavity region. An automatically controlled valve and/or damper operatively connected to the vacuum pump provides the vacuum where needed as described herein. A single vacuum pump in one implementation is located on and travels with gantry 116. In one implementation the single vacuum pump is operatively connected both to the cavity vacuum system and vacuum system 214 bias hoses and/or ducts and is located external to the gantry. In this implementation a hose management system known in the art maintains a portion of the hose outside of the gantry within frame 114 to allow for free movement of gantry 116.

Referring to FIG. 7, belt 124 includes a plurality of openings 242 allowing air to enter therethrough in response to vacuum 214. In one implementation the pattern of plurality of openings 242 through belts 124 are sufficient to allow the vacuum to be applied to an underside of the material being processed adjacent the cavity opening 174. In one implementation the vacuum applied is sufficient to maintain two or more stacked materials together provided at least the first material adjacent belts 124 is porous.

In one implementation horizontal belt 126 does not extend entirely above lower housing 202 and lower portion 206 and lower portion 212 of joining system 128 and sewing system 130 respectively. Referring to FIG. 5C a horizontal belt 126 diversion system includes a first upper bar 243 a first bottom bar 244, a second bottom bar 246 and a second upper bar 248. Bars 243, 244, 246 and 248 may rotate and/or include a roller bearing. A portion of horizontal belt 126A (see FIG. 5A where 126 is shown in dashed lines if a horizontal belt diversion system were employed) would extend below lower housing 202 and lower portion 206 as sewing system joining system 128 and cutting system 134 moves along gantry 126 along a cross system axis which is perpendicular to longitudinal axis 118. In one implementation a portion of horizontal belt 126A would extend below the gantry but above the lower portions of belts 124. The cross system axis and longitudinal axis 118 lie in a plane that is generally perpendicular to gravity when system 110 is in an-use orientation. Stated another way longitudinal axis 118 lies along the X axis as shown in FIG. 1 and

FIG. 2 and the cross system axis lies along the Y axis as shown in FIG. 1 and FIG. 2. Referring to FIG. 5C in one embodiment lower housing 202 and lower portion 206 are elevated from a base member 250 that moves along the cross system axis or a line parallel to the cross system axis. In one implementation, sewing system joining system 128 and cutting system 134 move together and in one implementation joining system 128 and cutting system 134 may move independently of one another along or parallel to the cross system axis. Referring to FIG. 5B and FIG. 5C, horizontal belt 126 forms a second cavity within cavity 162. In one implementation system 110 includes two or more gantries 116 acting independent of one another, wherein each of gantries includes a material treatment module. In one implementation each of the multiple gantries includes different modules. For example, one gantry includes a cutting module, while another gantry includes a sewing module. Similarly, one or more of the multiple gantries may include more than one sewing module. In one implementation at least one of the multiple gantries includes more than one cutting module. In one implementation one gantry includes a sewing unit that provides a cross stitch, while a second gantry includes a sewing unit that provides a lock stitch. In one implementation, one gantry includes two sewing unit, where the sewing units perform different stitch types.

In one implementation belt 126 is replaced by a telescoping plates or the like that extend and retract as the gantry housing holding the material processing modules such as the joining and cutting modules move back and forth between the longitudinal sides of frame 114. In this manner the region directly above the cavity opening would be free of any belt material. In one implementation the second belt in the claims provided herein below is replaced with telescoping plates.

In one implementation belt 124 has several features. In one implementation the friction on one side of the belt that comes into contact with materials 112 has a higher coefficient of friction than the second side of the belt that does not contact materials 112. Belt 124 includes a plurality of perforated holes that allow vacuum air flow to secure materials 112 so the joining operation such as sewing/and cutting operation does not move the materials 112. In one implementation belt 124 9s must be thin and flexible to enter and exit the gantry as described herein. In one implementation belt 124 is sufficient thin and/or flexible to bend over the small rollers where belts turn downwards 110-120 degrees into cavity 162. In one implementation belt 124 has minimal stretch along the longitudinal axis and is durable to last 1 or 2 years in heavy use. In one implementation the commercially Habasit FAB-2E material is used. But there are numerous other brands and types to choose from. In one implementation belts 124 include parallel grooves on the back side to assist in belt tracking. The belt grooves will match grooves on one of the rollers or the rounded path as shown in FIG. 8 to ensure tracking. In one implementation each belt 124 may vary in width perpendicular to the longitudinal axis of the belt from 25 mm to 100 mm. However, the width of each belt 124 may be less than 25 mm or greater than 100 mm. In one implementation the width of each belt is 25 mm. In implementation each belt has two rolls of holes. In one implementation each hole has a diameter of 4 mm. In one implementation each longitudinal row of holes are offset from one another such that the holes are offset from one another along or parallel to the cross system axis or Y axis.

In one implementation horizontal belt 126 is a single belt. In one implementation horizontal belt 126 is not perforated and has no holes except for the holes to allow a joining member and cutting member to extend there through. In one implementation horizontal belt 126 includes perforations to provide an air cushion to help slightly lift materials 112 over the active area (where the belt is moving below the fabric 112), so the friction between horizontal belt 126 and materials 112 does not push the materials 112 sideways in the cross system direction (along Y axis). In one implementation horizontal belt 126 has a top surface that faces/contacts materials 112 with a low coefficient of friction. Horizontal belt 126 has a strong tensile strength to allow it to move lower housing 202 and lower portion 206 along the cross system axis. In one implementation horizontal belt 126 is driven by a motor and the connection between horizontal belt 126 and lower housing 202 and 206 is what moves lower housing 202 and lower portion 206 including base member 238. One of rollers 188, 190, 192 and 194 is a drive roller that moves horizontal belt 126 along the horizontal belt 126 path. In one implementation base member 238 is driven by a motor independently of horizontal belt 126. In one implementation base member 238 is driven by a motor is operatively connected to horizontal belt 126 and moves horizontal belt 126 when base member 238 is moved along or parallel to the cross system axis.

Referring to FIG. 4 gantry 116 includes a housing formed with a plurality of rib members 236 providing guidance for each belt 124. Rib members 236 extend from a base member 238 toward an upper member 240 proximate the cavity opening.

Referring to FIG. 2, materials 112 may be fed to system 110 by a first feeder roll 252 feeding a first material and a second feeder roll 254 feeding a second material. A take-up roll 256 is configured to take up the joined first material and second material. In one mode of operation materials 112 are placed onto the upper surface of belt 124 through gantry 116 along longitudinal axis 118 between the entry side of system 110 toward the exit side of system 110 in the region in which gantry 116 can operate to join and cut materials 112. Gantry 116 is automatically moved along the longitudinal axis 118 as joining system 128 and cutting system 134 are moved along the cross system axis of system 110 to join and cut materials 112 in a predetermined pattern. In this first mode, materials 112 remain stationary during the joining system 128 and cutting system 134 operations. Once the materials 112 have been joined and cut the processed material is moved toward the exit by take-up roll 256. In one implementation belts 124 are moved in exit direction such that the processed materials 112 are moved from the entry side toward the exit side. In one implementation where parts of materials 112 are joined and cut apart take-up roll 256 can be replaced with a tray or another conveyor to move the joined and cut products to packing or for further processing.

In one implementation system 110 includes a vision registration system to register a joining path where materials 112 are joined and a cutting path where materials 112 are cut to a printed image. In one implementation the vision system will be able to obtain an image of the materials 112 where a printed image is on the face of the materials facing downward, so that the printed fabric materials can be joined (sewn) and cut in registration with the printed image. In one implementation a first camera is mounted above the material being processed on the gantry and movable with the gantry. In one implementation a second camera is fixed relative to system 110 and does not move relative to the frame.

In a second mode of operation, materials 112 that are not part of a roll are placed on belts 124 (either manually or by a robotic loader) between the upper member of gantry 116 and horizontal belt 126. In this mode materials 112 remain stationary relative to frame 114 as gantry 116 is moved along the longitudinal axis 118 and joining system 128 and cutting system 134 are moved along or parallel to the cross system axis to join and cut materials 112. The processed materials 112 may then be manually removed from system 110 (either by hand or by a robotic loader) or belts 124 are moved such that the processed materials are moved in a direction toward the exit side of system 110.

In a third mode of operation materials 112 are separate from a roll and placed on system as described above with respect to the second mode of operation. In this third mode belts 124 move toward away from the exit side to move the material toward and away from the exit side as gantry 116 also moves along longitudinal axis 118. Joining system 128 and cutting system 134 move along or parallel to gantry 116 in the cross-system axis as described herein. Two or more layers of rolls or two or more sheets can be loaded on top of each other to be sewn and cut together. In one implementation system 110 is used for quilting in which an inner foam layer is between two outer layers of fabric. In one implementation system 110 is also used for embroidery.

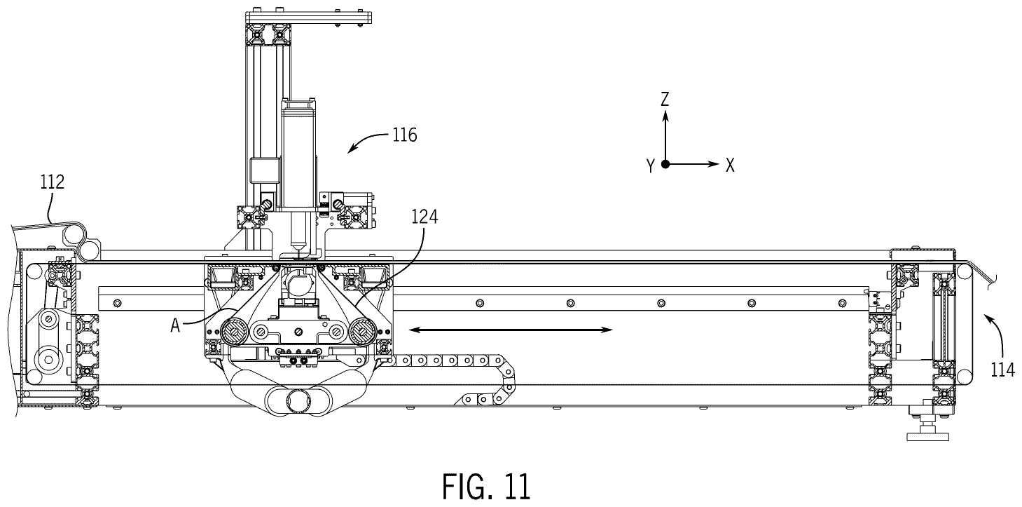

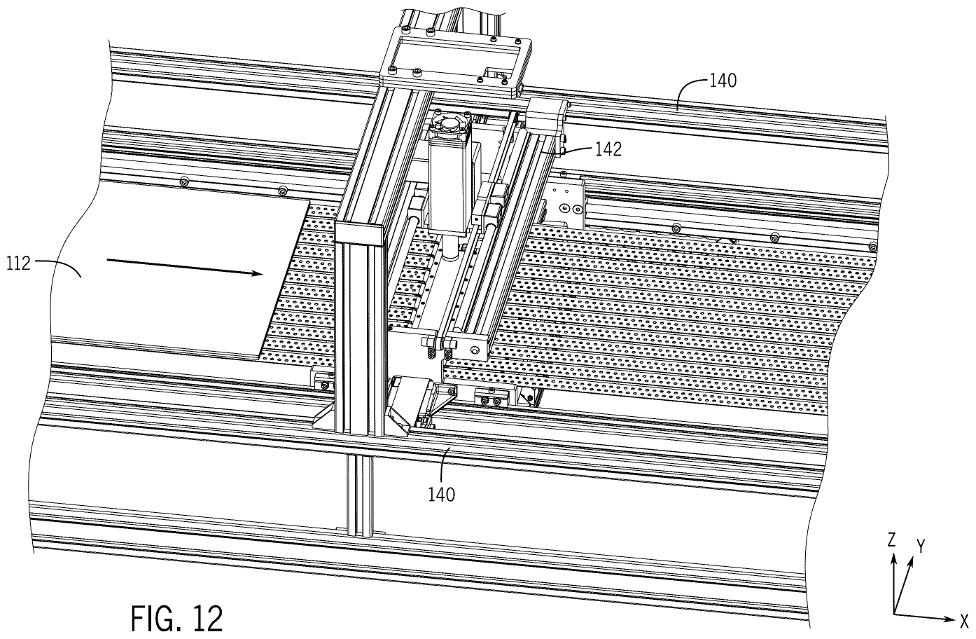

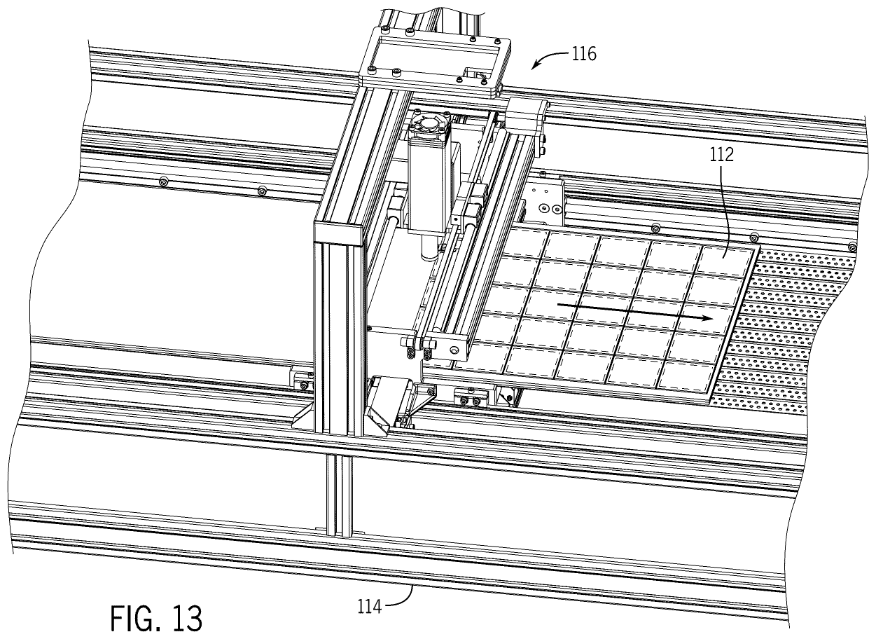

Referring to FIG. 2 and FIG. 11, in the first mode belts 124 are fixed relative to bars 150a, 150b, 152a, and 152b. However, the portion of belts 124 between bars 150a and 152a move along the belt path through gantry 116. Referring to FIG. 2 a point A on belts 124 in a first position is moved through gantry 116 as gantry 116 is moved from the exit side toward the entry side. The vacuum created by vacuum system 214 helps to maintain materials 112 in a stationary position relative to frame 114 as gantry 116 moves along longitudinal axis 118.

In one implementation system 110 includes processing a flexible or rigid material from both ends simultaneously on a flatbed formed by belts 124. In this implementation a second gantry 116 may be used that includes additional process modules to be used separately or in conjunction with joining system 128 and/or cutting system 134. The second gantry system could also include a second joining system 128 and a second cutting system 134. It is also contemplated that a second system 110 may be used in serial with a first system 110. For example when processing material to create automotive airbags a first system 110 could have special vent holes on one side and then joined to another material in a second system 110. Further straps and fitting or other tabs can also be added (with a robot) on the first system run and then sewn together with layer #2 in a 2^{nd} run on the second system.

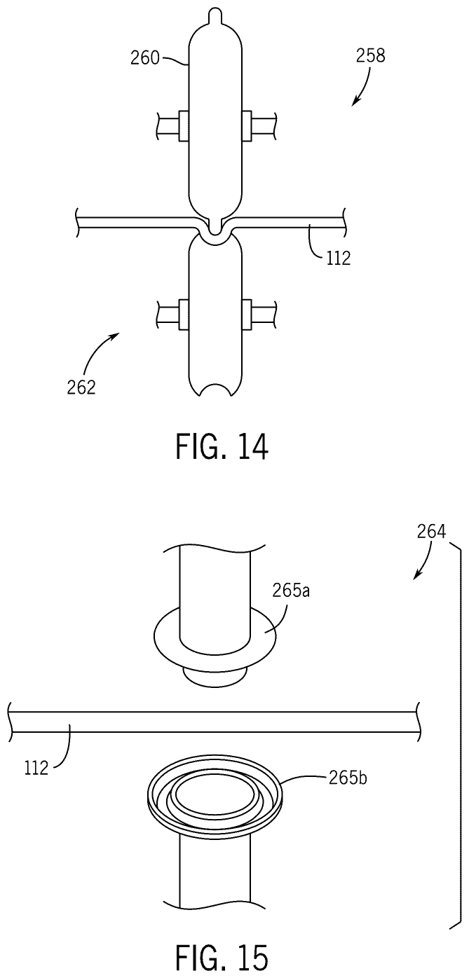

Creasing Tool: Referring to FIG. 14, a creasing module 258 includes an upper member 260 supported by gantry 116 and a lower member 262 supported by base member 250. Creasing module 258 may be used in the creasing of folding cartons and corrugated materials, utilizing a male and a female hard tool die to create a quality crease (fold). Creasing module upper member 260 and lower member 262 form the male and female portions a creaser and are manipulated by gantry 116 the two opposing creasing wheels are moved together simultaneously, with a male creasing wheel in the upper tool position and female creasing wheel in the lower position (inside the moving cavity). Note that creasing module 258 includes independent vertical movement of the male creasing wheel and the female creasing wheel to engage and disengage the wheels from materials 112 being crease. In one implementation both wheels will be operating in the same direction (tangentially) and synchronously in the X and the Y direction. In one implementation the male wheel is positioned in the cavity and the female wheel is positioned above the material being creased mounted outside of the cavity.

Referring to FIG. 15 a Grommet insertion module 264 is used independently or in conjunction with joining system 128 and/or cutting system 134 to insert one or more grommets into materials 112. Grommets are used to avoid tearing, to add strength, or for aesthetic value in connection with sewn goods such as banners, flags, tarps, sails, bags, curtains, shower curtains and more. A Grommet typically consists of two round parts, which are pressed together from both sides into a precut hole. Using system 110, a grommet dispensing tool supported by an upper portion 265a of gantry 116 will automatically insert the top grommet part. A matching lower tool 265b (inside the moving cavity) will dispense the lower grommet part after which the two parts are pressed together to secure them. By adding automated insertion of grommets, the system 110 will be able to sew, cut and add grommets thereby enabling fully automated production of a wide range of sewn goods. A grommet is a ring or edge strip inserted into a hole through thin material, typically a sheet of textile fabric, sheet metal or composite of carbon fiber, wood or honeycomb. Grommets are generally flared or collared on each side to keep them in place, and are often made of metal, plastic, or rubber. They may be used to prevent tearing or abrasion of the pierced material or protection from abrasion of the insulation on the wire, cable, line being routed through the penetration, and to cover sharp edges of the piercing, or all of the above. A small grommet may also be called an eyelet, used for example on shoes, tarps and sails for lacing purpose

A description of an automated grommet known equipment can be found at: https://plastgrommet.com/us/grommet-presses/automatic/multipress.php. By separating the upper portion of the automated grommet equipment from the bottom portion and placing the upper portion in a module supported by the upper portion of gantry 116 and placing the bottom portion in a lower module supported by base member 250 below materials 112. The automated system is integrated into system 110. The use of the automated grommet module would allow for banner, curtain and tarp making fully automated including roll-off, sewing, cutting and grommeting all in one system. Banners, curtains, tarps could also be sewn, cut and grommeted in non-rectangular shapes without any added cost. It would also be possible to insert grommets at any position on a surface of materials 112 and not just at the edges. New creative products can be produced with system 110 when sewn products do not need to be rectangular and can be grommeted in the middle (or anywhere) for pole or wire support, such as simple tents, temporary awnings and more.

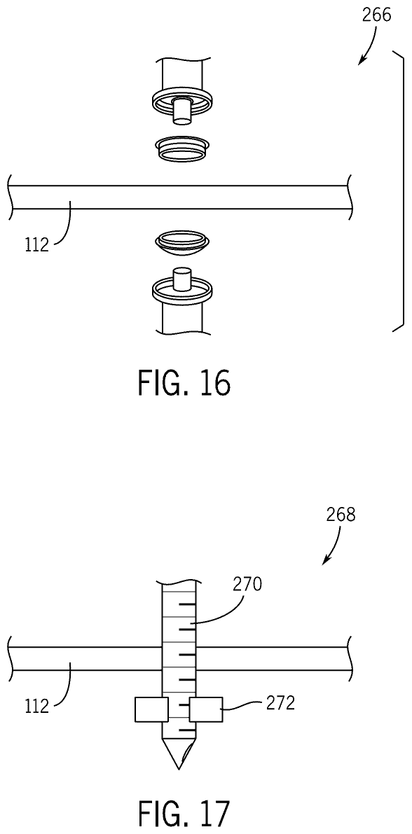

Referring to FIG. 16 a metal snap and button insertion module 266 is used independently or in conjunction with joining system 128 and/or cutting system 134. Snaps and buttons are used provide for temporary attachment of fabric pieces to each other, as opposed to grommets that allow the fabric to be mounted in other applications such as boat covers, grill covers, bags, tents, luggage. Just like for grommets, there are two pieces with snaps, except that two such dual attachments are on the two fabrics to be connected, one a male and the other a female piece that “snap” together and hold. In the metal button application, rather than being sewn on, the button is attached via a bottom pin that is inserted through the fabric into the button head. By adding automated insertion of buttons and snaps, system 110 will be able to sew, cut and add snaps/buttons thereby enabling fully automated production of a wide range of sewn goods

Referring to FIG. 17 in one implementation cutting system 134 includes a routing tool 268 to cut materials 112. A router module includes a top portion supported by the upper portion of gantry 116 and a lower portion supported by the lower portion of gantry 116 such as base 250. When using smaller diameter routing bits or drills (ranging from 0.1 mm up to 5 mm in diameter) these tools are prone to breaking when moving in the X or Y direction on a flatbed table. Therefore, the speed the tool is moving with must be significantly reduced. The rotation speed of the bit or drill must also be reduced to avoid vibrations which will cause poor edge quality of the materials being processed. By supporting the bit 270 or drill at the top and at the bottom in a small bearing 272 within the moving cavity the bit or drill can move at a higher X and Y speed and a higher rotation speed, or use thinner bits which is an advantage in many situations (less dust, less material waste, finer details can be routed, higher speed). It is also possible to process thicker materials in one routing pass vs several subsequent passes. In this manner a router bit is held both by the upper module and the lower module.

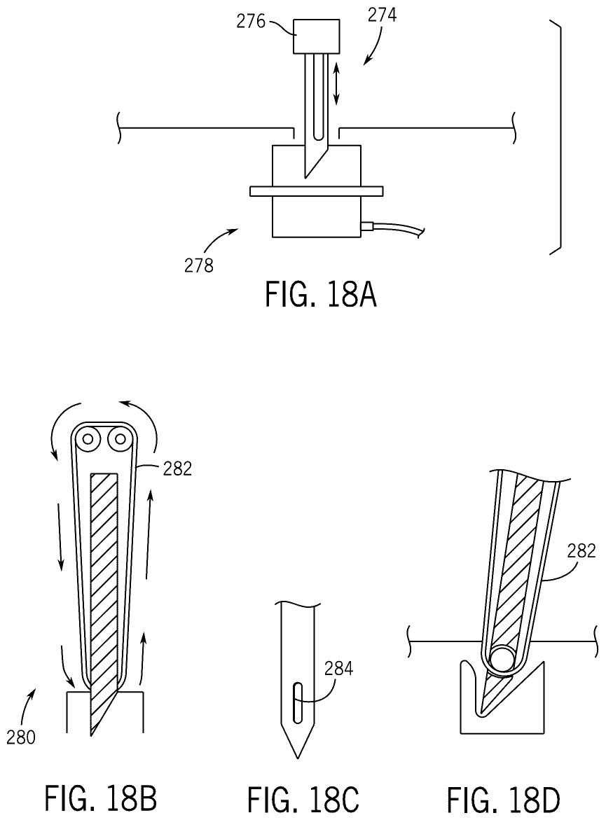

Referring to FIG. 18A-FIG. 18D cutting system 134 includes a long thin oscillating blade 274 that is supported at one end by an upper module 276 attached to the upper portion of gantry 116 and supported at the other opposing end by a lower module 278 within the cavity 162 via aperture 284. The oscillating blade module is used for cutting thru multiple layers (up to 100 layers or more) of fabric up to 10 cm-20 cm thick, or when cutting thru harder & thicker materials, blades are prone to flex causing inaccurate cutting or breaking. Though the oscillating blade system could be used with multiple layers of fabric that are less than 10 cm or greater than 20 cm. The cutting speed, number of fabric layers and material thickness is reduced using the oscillating blade system. In some cases, the flatbed motion control software must also dynamically adjust (slow down) the cutting movements (rotation, lifts, lowering, oscillations) to compensate for the flexing and to avoid breaking the blade. By using system 110 the oscillating blade can be lowered into the moving cavity 162 and the blade thereby supported from both the upper blade holder and the cavity below. This will result in faster cutting of thick stacks/layers of fabric or thicker/harder materials. It will also be possible to automatically sharpen the part of the blade when it is inside the cavity. In one implementation the oscillating blade and holder in the cavity are tangentially controlled. In this manner the holder pivots as the blade pivots.

Referring to FIG. 18B, cutting system 134 is a wire cutting module 280 that uses a thin metal wire or cable 282 for mechanical cutting of material such as foam, nonwoven textiles, wood, glass, stone, ferrites, metals, crystals etc. Industrial wire saws are usually powered. Wire saws are classified as continuous (or endless, or loop) or oscillating (or reciprocating). Sometimes the wire itself is referred to as a “blade”. In some applications the wire moves at high speeds up to 200 km/h.

Cutting system 134 may include a heated wire module in which a heated wire element is used to cut materials 112. A heated wire module would include an upper portion supported by the upper portion of gantry 116 and a lower module supported by the lower portion of gantry 116 such as base member 250 within cavity 162.

Each of the modules discussed herein can be used with system 110 either alone or in combination with one or more of the other modules discussed herein. It is further contemplated that system 110 includes one or more additional gantries that are automatically controlled to perform operations on different regions of materials 112 simultaneously.

System 110 supports materials 112 without the need for a separate frame member or the need to separately secure the longitudinal edges of materials 112. In one implementation system 110 operates to join, cut and perform the other functions to materials 112 identified herein without securing the longitudinal edges of materials 112. In one implementation system 110 operates to join, cut and/or perform the other functions to materials 112 without securing any edge of materials 112 relative to frame 114.

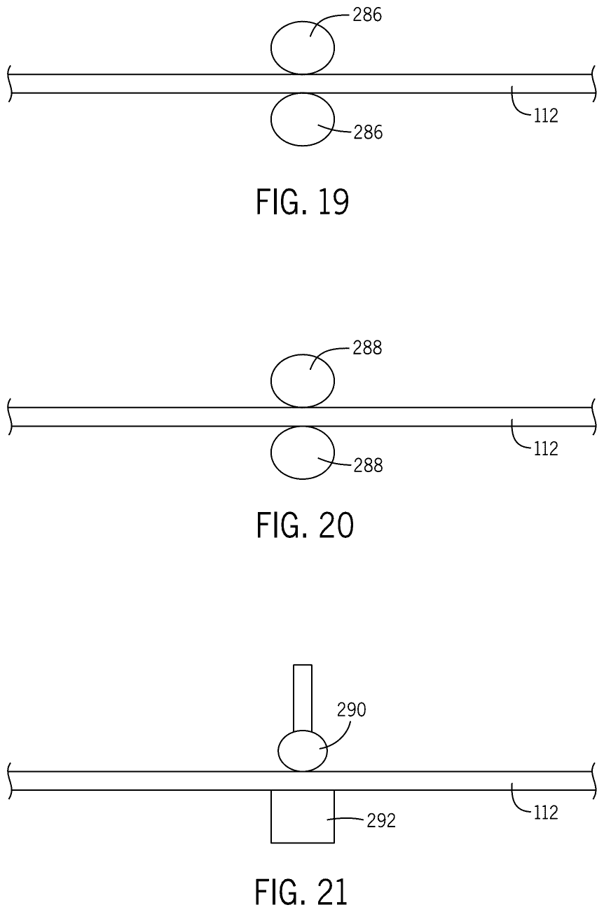

Referring to FIG. 19 in one implementation the upper module and the lower module include embossing wheels 286 that emboss a pattern on materials 112. Referring to FIG. 20. In one implementation upper module and/or the lower module can include a printing module to impart a printed image onto one or both sides of materials 112.

Referring to FIG. 21, in one implementation, joining system 128 includes an ultrasonic welding system 132 that ultrasonically joins materials 112 together. The upper module includes an ultrasonic horn 290 as is known in the art. The horn vibrates ultrasonically and acts to bond plastic materials 112 together positioned between the horn and an anvil in the lower module. In one implementation one or both the horn and anvil 292 are rotary members. In one implementation the axis of the rotary members pivots in the direction that gantry is moving relative to frame 114. Ultrasonic welding is an industrial process whereby high frequency ultrasonic acoustic vibrations are locally applied to work pieces being held together under pressure to create a solid-state weld. It is commonly used for plastics and metals, and especially for joining dissimilar materials. In ultrasonic welding, there are no connective bolts, nails, soldering materials, or adhesives necessary to bind the materials together. The benefit of ultrasonic welding is that it is much faster than conventional adhesives or solvents, and it will create ab airtight bond without punching holes in the materials as the case with sewing. Ultrasonic welding can be used for both hard and soft plastics, and metals. For ultrasonic welding two types of machines are used-First, machines with a 1) fixed sonotrode and a rotating wheel for fast and precise welding (especially for curves) and 2) second, machines with a rotating sonotrode and a rotating wheel for fast welding (for straight seams). System 110 has the ability to provide pressure from both sides of the work piece while the two tools are moving synchronously in the X and the Y directions, providing for a fully automated welding process of various materials. This allows the welding of non-linear contours. After welding the pieces can be cut while the materials are still fixed by the vacuum hold down. In one implementation the ultrasonic horn uses a rotating wheel on top and a receiving metal plate (anvil) below (or alternatively another wheel to reduce drag while moving). In one implementation when the horn and anvil are wheels, they will be operating in the same direction (tangentially) and synchronously in the X and the Y direction.

In one implementation joining system 128 includes a laser welding system that joins materials 112 together using laser energy. Laser welding systems may use various types of lasers including a CO2 laser or a diode laser that are often used for cutting fabrics. There are many advantages of laser cutting fabrics vs using a blade cutting tool: A laser system provides no mechanical force (friction) on the fabric as the laser uses a light beam to evaporate the cut path. The eliminates the risk that the fabrics moves during cutting. Further a laser provides finer for details to be cut at higher cutting speeds. A laser has the ability to cut several layers of materials 112. A laser can Seal the free edges of the material thereby reducing fraying when cutting fabrics containing polyester

The fumes can be extracted into one smaller hole within the moving cavity (into a hole next to the needle sewing hole). In regular laser cutters, a full surface area as large as the flatbed table itself will normally have vacuum extraction. As discussed herein a vacuum within cavity 162 effectively vacates fumes associated with the laser cutting process. Stated another way within the moving cavity 162 there will be a mechanical laser diffusing surface with vacuum extraction. By reducing the vacuum area from several square meters of the entire frame to a single hole only a few mm in diameter will allow much higher vacuum flow and efficiency. This also saves energy compared to vacuum extracting a full size machine. Typically, full size extraction fumes will be vented outside, so new air coming into the building must be heated or cooled with HVAC (heating cooling air conditioning) systems. A typical 20 hp blower will push a lot of air volume outside and require a lot of new fresh air to enter. That is especially expensive to operate during air conditioning season. In one implementation the laser beam is the range of 0.05 mm to 0.1 mm. In one implement the hole through horizontal belt 126 is larger than the laser beam. In one implementation the hole size in horizontal belt 126 that the laser beam passes is between 1 mm and 2 mm.

System 110 is capable of dual sided processing by using an upper portion and a lower portion located on opposite sides of materials 112. This is accomplished by moving the opening through which the upper and lower portions interact with one another and materials 112. The opening is provided by the belt path of belts 124 that moves a portion of belt 124 through the lower portion of gantry 116 about cavity 162.

### Laser Feedback System

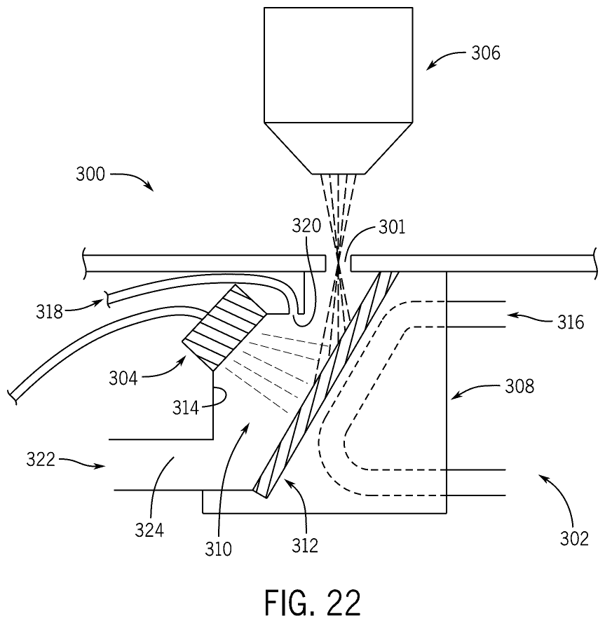

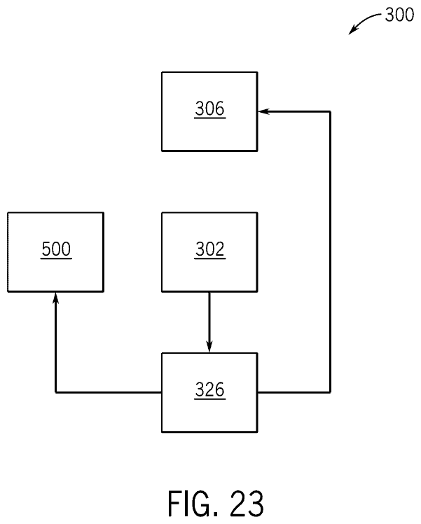

Referring to FIG. 22 and FIG. 23 cutting system 134 is a laser cutting system in which a laser is generated in upper portion 210 and a base member positioned within cavity 162 or in lower portion 212 dissipates any laser energy and removes fumes after the materials have been cut. In one implementation an automatic laser calibration system 300 automatically adjusts the laser energy to regulate the power of the laser during movement of the laser head over a specific substrate that the laser is acting upon. Laser calibration system 300 includes a laser beam dump device 302 including a light sensor 304 that detects laser light that is a function of the laser energy being transmitted by the laser beam of the laser nozzle 306 in upper portion 210. In one implementation light sensor 304 includes a phototransistor such as the one available from Vishay Semiconductor Opto Division under part number BPW85B having a frequency of 180 kHz. The speed in which measurements can be taken allows automatic laser calibration system 300 to adjust the strength of the laser in real time to account for change in material thickness, material color, material seams or other material variations as the material is being processed by system 110.

In one implementation laser beam dump 302 is positioned within lower portion 212 of cutting system 134. Laser beam dump device 302 is secured to gantry 116 and to cross member 142 to allow laser beam dump device 302 to be moved along longitudinal axis 118 and in a cross-table direction perpendicular to a direction parallel to longitudinal axis 118. Laser beam dump 302 includes a housing 308 defining a chamber 310 including a highly reflective surface 312 located therein. Laser beam dump 302 devices are well known in the art. U.S. Pat. No. 10,345,561 describes laser beam dump devices and is incorporated herein by reference to describe the general operation of a laser beam dump 302 device. Highly reflective surface 312 can be in the shape of a cone or angled planar surface that reflects the laser energy that enters into chamber 310 toward an inner surface 314 of the housing 308.

In one implementation a laser light sensor 304 is placed on or adjacent to surface 314 that detects an amount of light energy that is received from highly reflective surface 312. The amount of light energy detected by light sensor 304 is a function of the light energy emitted from laser nozzle 306 after the laser beam cuts through the material being cut by the laser. The signal from the light sensor is provided to a controller 326 that acts to increase or decrease the laser energy being emitted from laser nozzle 306 to a predetermined strength.

In one implementation, a user calibrates the laser energy during a setup stage based on the type of material being cut and the speed in which the laser nozzle is being moved over the material being cut. For example, the amount of laser energy in the laser beam applied to the material being cut is a constant predetermined value for a specific speed of the laser nozzle moving over the material. In one implementation the speed of the laser module movement relative to the material may vary depending on the type of cut being performed. For example, movement of the nozzle head in a straight line may be a first speed measured in inches/minute while movement of the nozzle head in an arcuate or non-linear line may be a second speed different than the first speed. In one implementation the second speed is less than the first speed. In one implementation the actual amount of energy being emitted by the laser beam varies during the cutting operation.

In one implementation light sensor 304 may detect a percentage of energy being emitted from the laser beam. For example, once the laser energy has been set to obtain proper cutting of a specific type of material at a given speed, the amount of light energy being detected by light sensor 304 is determined. By way of a nonlimiting example after the laser beam cuts the material the amount of laser energy that enters laser beam dump device 302 and reflected from highly reflective surface 312 light sensor 304 may detect 10% of the energy of the laser beam. This desired light detection value referred to herein as the calibration value is then stored during actual cutting of material during a production run. If during the production run the amount of energy detected by laser beam dump device 302 falls below the calibration value of 10%, the controller signals to the laser device to increase the strength of the laser until laser light sensor 304 is recording the proper light detection value. Similarly, if the amount of energy detected by light sensor 304 is greater than the calibration value of 10% the controller sends a signal to the laser beam to reduce the level of energy until the energy detected by light sensor 304 is within a predetermined value of the desired light detection value. In one implementation when the calibration value exceeds an upper limit, the controller provides instructions to increase the speed of the gantry through actuator or motor controls 500. Similarly, in one implementation when the calibration value is lower than a lower limit, the controller provides instructions to decrease the speed of the gantry. In one implementation, but the calibration value being outside the lower limit or the upper limit the controller provides instructions to both change the speed of the gantry and change the energy of the laser.

Referring to FIG. 15, laser beam dump device 302 includes a cooling loop 316 that circulates a coolant adjacent highly reflective surface 312 to prevent heat damage to highly reflective surface 312. In one implementation, an air pump 318 introduces air via at least one aperture 320 into chamber 310 of housing 308. The air pumped into chamber 310 is removed via a second exit aperture by a vacuum 322 applied to the second exit aperture 324. In one implementation the vacuum applied to the chamber 308 is connected to vacuum system 214 or may be connected to a separate vacuum. The volume of air introduced and removed from housing 308 per unit of time can be varied depending on the amount of particulate being formed within the housing 308 to ensure that light sensor 304 accurately measures the light energy reflected from highly reflective surface 312. In one implementation there is no air pump 318, but rather ambient air enters at least one aperture 320 as a result of the application of the vacuum pressure through second exit aperture 324.

In one implementation an external air filter is installed in the vacuum system 214 to filter out any unpleasant smells and pollutants from the fumes being vacated from the system. Since the extraction of the fumes is directly below the cutting position the opening 301 is between a 1 mm and 5 mm diameter hole and in one implementation opening 301 is a 2 mm diameter hole. This reduction assists in minimizing a portion of the material from being pulled into the aperture. This results in several magnitudes of concentration of the extraction area which significantly reduces the size of the required vacuum pump and the energy needed to drive it. A smaller filter system can also be applied. It is expected that the volume of air being removed will be reduced by factor 10-100 vs current technology where a flat surface (the size of the overall system) must be vacuumed. Stated another way since there is a moving vacuum 322 operatively connected to housing 308 the size of opening 301 may be small since any fumes in the laser beam dump device 302 are evacuated through second exit aperture 324 and do not need to be evacuated by a vacuum located on the top side of the material proximate laser nozzle 306. Additionally, the use of laser beam dump device 302 in cavity 404 eliminates for belts that are formed of metal or other material that will not burn in the presence of the laser energy. Metal belts reflect the laser energy and result in a burning or brown residue on a portion of the material being processed. A nonmetal belt material minimizes this condition. Further as discussed herein the laser beam dump device 302 that moves with the gantry and along the gantry eliminates the bounce back effect of the laser energy. In one implementation a vacuum is applied to the top portion of the laser module and a separate vacuum is applied to the lower portion of the laser module and both the top portion and the bottom portion move with the gantry along longitudinal axis 118 and in the cross-frame direction along the gantry. The cross-frame direction is perpendicular to longitudinal axis 118 and not perpendicular to the material being processed (not in the Z-axis direction). As discussed herein, a separate vacuum source is provided via the cassettes to the material being joined and/or cut through apertures in belts 124. The volume of air that needs to be removed from the laser within the cavity is much less than the volume of air that needs to be removed to hold down the material via the cassettes closely adjacent to the opening of the cavity.

It would also be possible to significantly increase the airflow speed by which will further remove the risk that fumes will escape the system and result in bad smells in the room and for the operators.

Laser nozzle 306 and laser beam dump device 302 move with the gantry in both the longitudinal direction parallel to or along longitudinal axis 118 and along the longitudinal axis of the gantry that is perpendicular to longitudinal axis 118 of the frame.

Certain materials being cut have threads or regions that require different levels of laser energy to be cut. Referring to FIG. 23 the feedback system includes a controller that can instantaneously change the energy level of the laser beam to ensure a proper cut through all of the different regions of the material being cut by the laser.

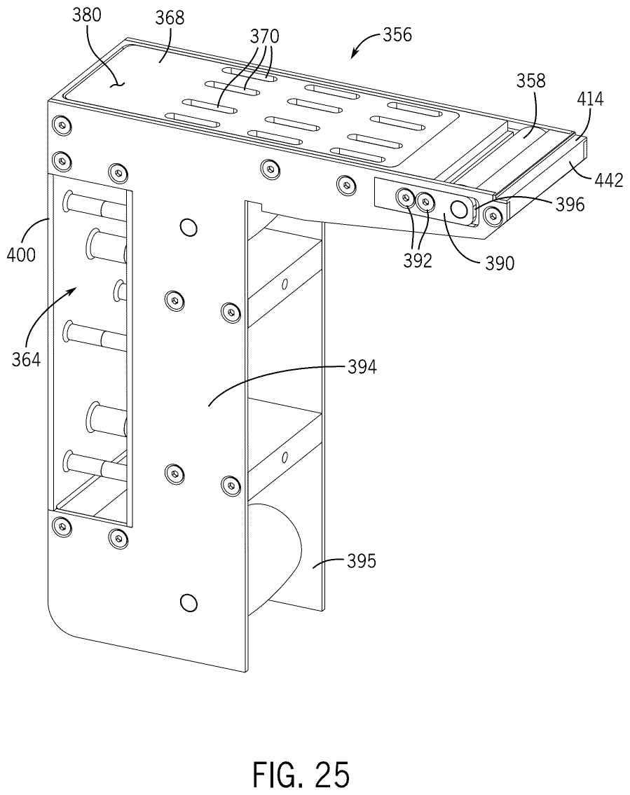

Referring to FIG. 1 and FIGS. 24-27 in one implementation cross member 142 of gantry 116 defining cavity 162 is formed by a first cross member plate 350 and a second cross member plate 352 and a base plate 354 extending perpendicular and between first cross member plate 350 and second cross member plate 352. First cross member plate 350 and second cross member plate 352 have an inner surface facing one another and an outer surface facing away from the inner surfaces. First cross member plate 350 and second cross member plate 352 generally lay in a plane that is perpendicular to longitudinal axis 118 (Y-Z plane). In this implementation first cross member plate 350 and second cross member plate 352 replace bars 150a, 150b, 152a and 152b in the implementation illustrated in FIG. 4 and discussed herein above. Referring to FIG. 25 vacuum system 214 includes a plurality of vacuum cassettes 356 that replace brackets 151, 153 and cross bars and rollers 155, 156, 158 and 160 of the implementation described herein above. A pair of vacuum cassettes 356 are provided for each belt 124. Vacuum cassettes 356 that are positioned closer to the proximal region 180 of system 110 will be identified by reference 356a and vacuum cassettes that are positioned closer to second distal region 182 will be identified by reference 356b.

Each vacuum cassette 356 includes a first upper roller 358, a second upper roller 360, and a lower roller 362. For description purposes vacuum cassette 356 and the features identified therein will be identified with a suffix “a” for the vacuum cassette 356 closer to proximal region 180 and with a suffix b for the vacuum cassette 356 closer to second distal region 182. Belt 124 extends over and about first upper roller first upper roller 358a of second vacuum cassette 356a toward and about second upper roller 360 of vacuum cassette 356a then toward and about first lower roller 362a of vacuum cassette 356a then below base plate 354 toward and about lower roller 362b of vacuum cassette 356b then toward and about second upper roller 360b of vacuum cassette 356b and then toward and about first upper roller 358b of vacuum cassette 356b and then toward second distal region 182. Each vacuum cassette 356 has a first region 364 that is in fluid communication with one of first duct 216 and second duct 218 and a second region 366 that is not in fluid communication with either first duct 216 or second duct 218. First region 364 of each vacuum cassette 356 is in fluid communication with an adjacent vacuum cassette 356. Second region 366 supports second upper roller 360 and lower roller 362.

Each vacuum cassette 356 includes a top plate 368 and includes a plurality of apertures 370 extending therethrough that is in fluid communication with a vacuum path 372 in fluid communication with first region 364. Vacuum path 372 is defined by the region between top plate 368, a bottom plate 374 and first region 364. Belt 124 includes a first surface 376 that contacts material being processed and a second opposed surface 378. An upper surface 380 of top plate 368 is in contact with second opposed surface 378 of belt 124. Note the top plates 368 of vacuum cassette 356 form the manifold through which the vacuum is applied through plurality of openings 242 of belts 124 to the underside of the material being treated or processed.

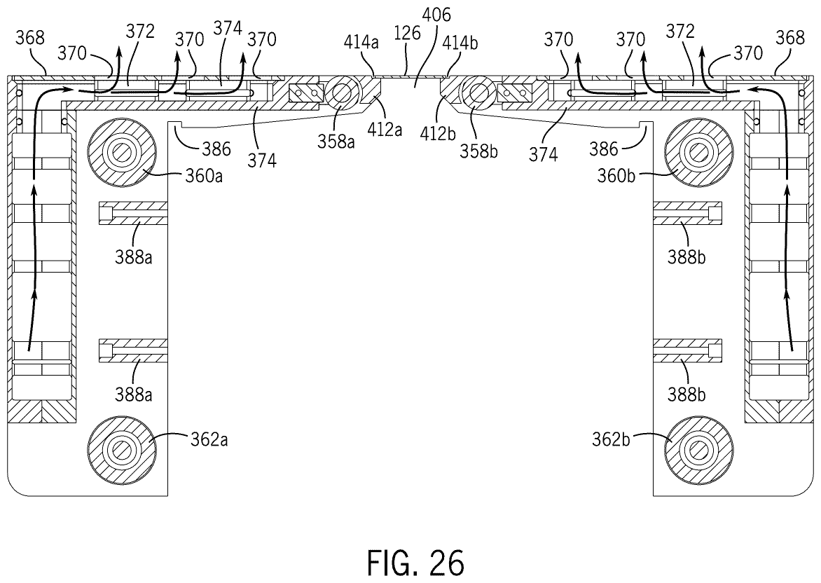

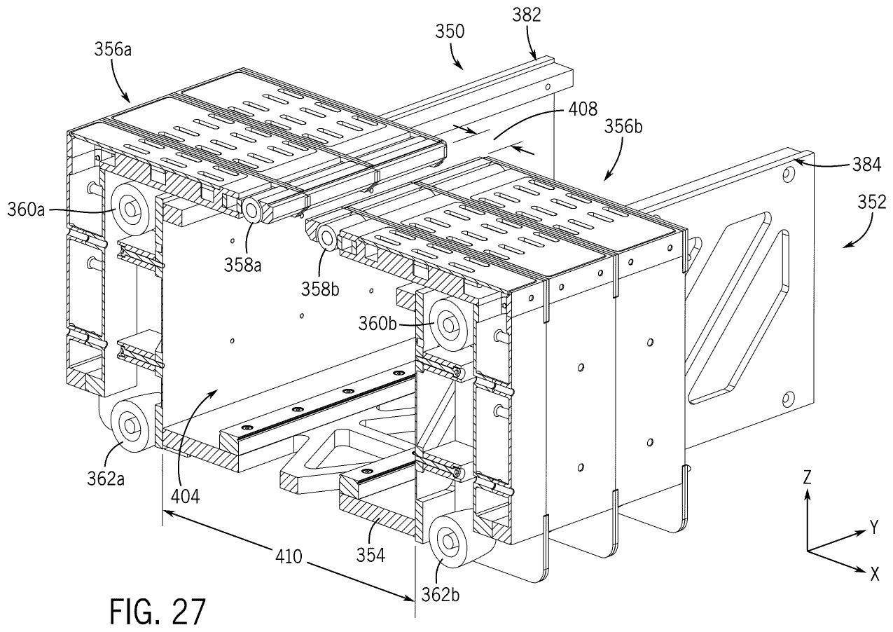

Referring to FIG. 26 and FIG. 27 first cross member plate 350 and second cross member plate 352 include a tab 382 and 384 respectively. Vacuum cassette 356a includes a notch 386 that receives tab 382 of first cross member plate 350 to position vacuum cassette 356 relative to first cross member plate 350 in an installed position. Similarly, vacuum cassette 356b includes a notch 386 that receives tab 384 of second cross member plate 352 to position vacuum cassette 356b relative to second cross member plate 352 in an installed position.

Vacuum cassette 356a is secured to first cross member plate 350 by a fastener extending though a boss 388 in second region 366 and is threadedly received within a threaded aperture in first cross member plate 350. Similarly, a Vacuum cassette 356b is secured to second cross member plate 352 by a fastener extending though a boss 388 in second region 366 and is threadedly received within a threaded aperture in cross member plate 352. Referring to FIG. 25 first upper roller 358 is secured to vacuum cassette 356 with an end adjustment plate 390. A pair of fasteners 392 secure end adjustment plate 390 to a side plate 394 to allow for adjustment of first upper roller 358 relative to vacuum cassette 356. In one implementation a second pair of fasteners secure a second end adjustment plate to a second side plate 395 to allow for additional adjustment of first upper roller 358. In one implementation fasteners 392 extend through both first side plate 394 and second side plate 395.

A gap 396 is provided by design between a leading edge of end adjustment plate 390 and side plate 394 to allow for movement of first upper roller 358 along a direction parallel to or along the longitudinal axis and within a plane (XY plane) perpendicular to the direction of gravity when vacuum cassette 356 and system 110 are in an installed position. Adjustment of first upper roller 358 allows a user to make adjustments to the movement of belt 124 about cavity 398. In one implementation first upper roller 358 has a crowned surface where the center of first upper roller 358 has a diameter that is greater than the diameter at the portions proximate side plates 394, 395. In one implementation each side plate 394, 395 includes an opening 400 into first region 364 allowing fluid communication between first regions 364 of adjacent vacuum cassettes 356. A leading vacuum cassette 356 is connected to one of first duct 216 and first duct 217 so that each first region 364 of each vacuum cassette 356 is connected to the vacuum system. Bottom plate 374 opposite top plate 368 includes an opening in fluid communication with one of first duct 216 and first duct 217 and first region 364. First duct 216 and second duct 218 travels with gantry 116 as gantry 116 moves longitudinally along longitudinal axis 118 of system 110 and moves in a direction perpendicular to longitudinal axis 118 as base member 250 moves along the longitudinal axis of gantry 116. A flexible hose 402 connected to a first duct 216 and first duct 217 is connected to a vacuum source outside of system 110. In one implementation first duct 216 and first duct 217 are connected to first region 364 of a respective vacuum cassettes 356a and 356b one a first side of frame. The first side of the frame is the side of the frame identified by an operator facing the frame with first longitudinal end 146 on their left and second longitudinal end 148 on their right. The second side of the frame is the side opposite the first side of the frame in the positive Y direction. In one implementation first duct 216 and first duct 217 are also operatively connected to the first region 364 of the pair of cassettes that are closest to the second side of the frame. In this manner vacuum is applied to the first region 364 of both sides of the line of multiple cassettes 356a and 356b.

Referring to FIG. 26, a cavity 404 is substantially rectangular, this shape is in contrast to the triangle shape of cavity 162 discussed herein above. Cavity 404 has a longitudinal opening 406 that allows a processing device to extend from above a material being processed to a region within cavity 404. The width 408 of longitudinal opening 406 along a direction parallel to the longitudinal axis of system 110 in one implementation is between 20 mm and 40 mm. In one implementation the width 410 of cavity 404 below lower plate 374 and base plate 354 in a direction parallel to longitudinal axis 118 of system 110 is between 200 and 400 mm. Stated another way the width 408 is between less than 50% of width 410. In one implementation longitudinal opening 406 is 30 mm and width 410 is 200 mm. In one implementation the height of cavity 404 from base plate 354 to bottom plate 374 of vacuum cassette 356 is less than width 410. In one implementation vacuum cassette 356 may be designed to have an opening greater or less than 40 mm depending on the tools being used.

Referring to FIG. 25 and FIG. 26 a front member 412 includes a ledge 414 that supports and guides a peripheral edge of horizontal belt 126. Stated another way a first peripheral edge 127a is supported on ledge 414a if vacuum cassette 356a and a second peripheral edge 127b is supported on ledge 414b of vacuum cassette 356b.

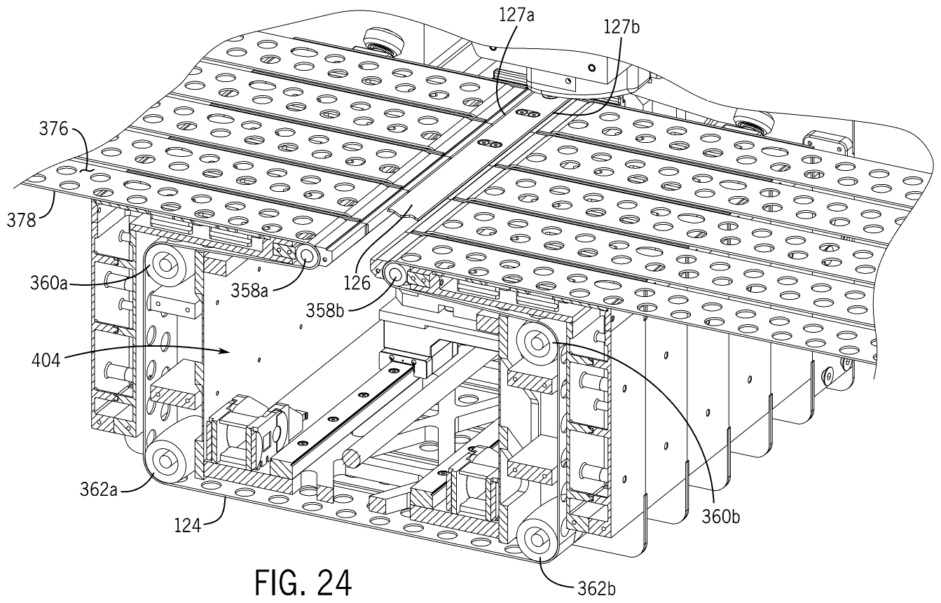

Referring to FIG. 24 and FIG. 25 a vacuum is applied through first region 364 and is not applied to cavity 398. Further in one implementation, a vacuum is only applied to the portion of belts 124 directly above top plate 368 of vacuum cassette 356. Referring to FIG. 1 and FIG. 24 Stated another way system 110 is free of vacuum between the terminal ends 146 and 148 of system 110 along longitudinal axis 118 except for the region above the top plates 368 of vacuum cassettes 356 that are immediately adjacent to longitudinal opening 406 of cavity 404.

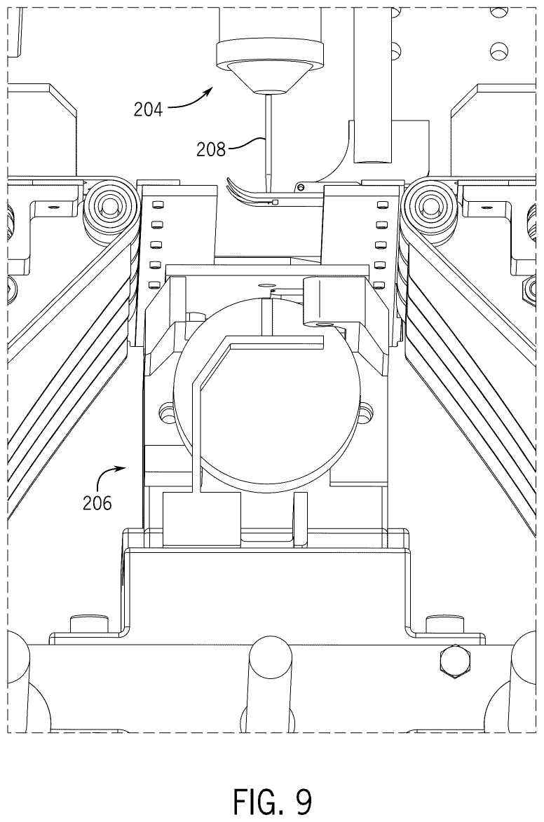

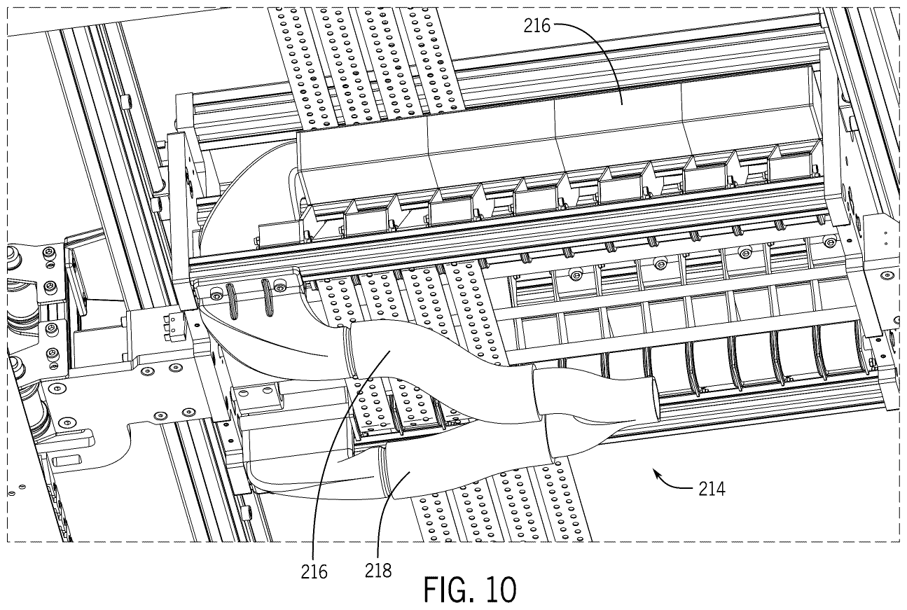

Note that all other aspects of system 110 discussed herein above operate in a similar manner with vacuum cassettes 356 and vacuum cavity 404 as with cavity 162 illustrated in FIGS. 1-11. Note that cavity 162 has a general triangular shape with the base of the triangle having a width parallel to longitudinal axis 118 that is greater than the cavity opening. Cavity 404 has a generally rectangular shape with the width parallel to longitudinal axis 118 being substantially the same from the base plate toward a region proximate the cavity opening. Note that the path of belt 124 through vacuum cassette 356a includes a portion that extends from the first roller toward the second roller in a direction generally opposite the direction of the belt path from first longitudinal end 146 toward the first roller. In one implementation Vacuum cassette 356 has two rollers to provide a triangular cavity shape with the base being larger than the cavity opening. In one implementation vacuum cassette 356 has more than 3 rollers. The term material as used herein may be a single material, or two or more stacked materials.

The term a material treatment system as used herein includes any of the cutting (including but not limited to laser, oscillating blades, routing, wire), joining (including but not limited to sewing, ultrasonic welding), creasing, grommet insertion, metal snap insertion, routing, embossing, and printing modules and systems discussed herein. The term surface treatment system as used herein includes any of the aforementioned modules that affect a surface of a material.

Vacuum system discussed herein provides a hold down force of the materials being processed or treated adjacent to the cavity openings. Note that in FIG. 26 the vacuum path 372 is identified with arrows extending through first region 364 and out of the plurality of apertures 370. Note that vacuum will operate to move air in the opposite directions of the arrows illustrated in FIG. 26. Stated another way the vacuum applied will move air through the materials being processed through plurality of apertures 370 and through first region 364 into one of first duct 216 and second duct 218.

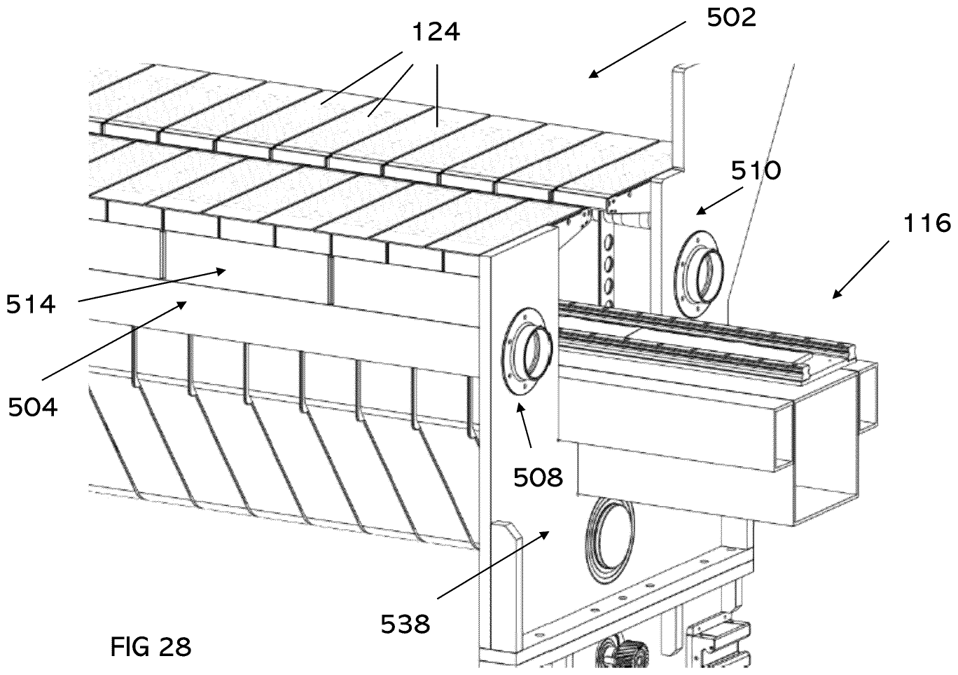

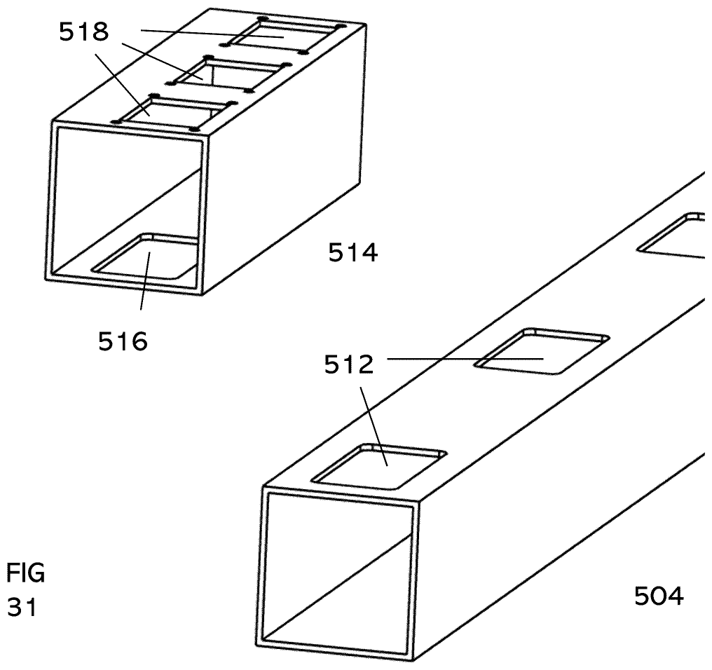

Referring to FIG. 28 and FIG. 31 in one implementation a vacuum manifold system 502 that moves with gantry 116 along the X axis of system 110. Vacuum manifold system 502 includes a first conduit 504 and second conduit 506 in a fixed relation to gantry 116, such that first conduit 504 and second conduit 506 move with gantry 116 as gantry 116 moves along the X axis of system 110. Each of first conduit 504 and second conduit 506 are connected to a vacuum source at a respective terminal end 508, 510 thereof. Each of first conduit 504 and second conduit 506 include a plurality of ports 512 along a longitudinal axis of first conduit 504 and second conduit 506 respectively. A plurality of vacuum shutoff chambers 514 are positioned adjacent an upper portion of first conduit 504 and second conduit 506. Each vacuum shutoff chamber 514 has a first opening 516 that is aligned with one port 512. Each plurality of vacuum shutoff chambers 514 includes at least one second opening 518 that is in fluid communication with a cassette 520. It is contemplated that the actuators that selectively open and close selective ports 512 could be located within first conduit 504 without the need for a separate vacuum shutoff chamber 514. Note that cassette 520 is also referred to herein as a vacuum cassette since the cassette is used to provide a vacuum to the side of the material facing the belts.

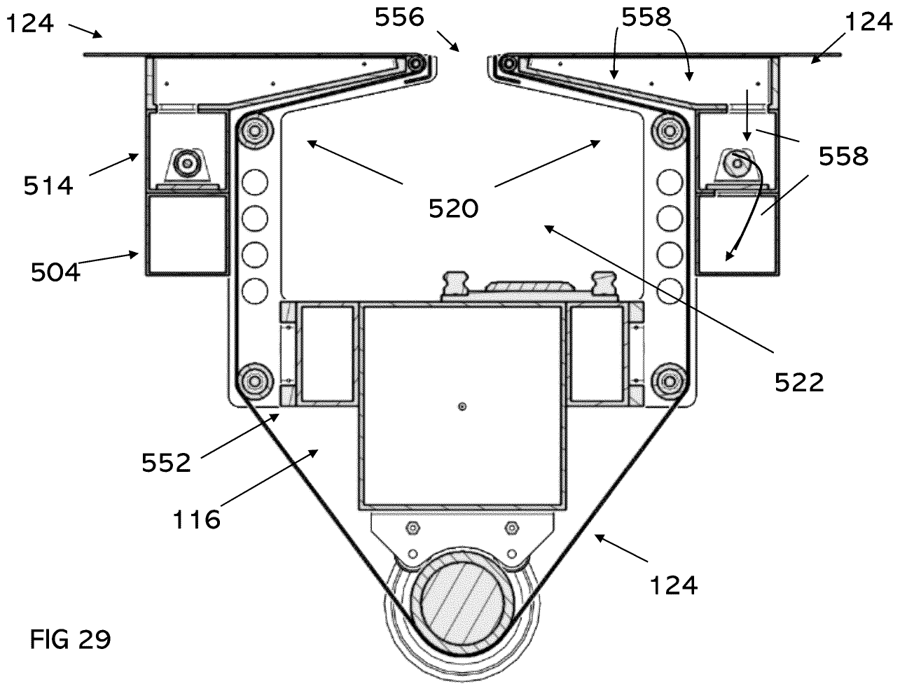

Referring to FIG. 28 and FIG. 29 each cassette 520 of a plurality of cassettes 520 support one of the plurality of belts 124 that extend around cavity 522. Each cassette includes a top plate 524 that includes openings 526 that are in fluid communication with a vacuum shutoff chamber 514 through an upper portion port 518. Cassette 520 includes a first region including vacuum chamber 530 through which air is drawn through from the top of the belt to the vacuum source and a second region that is secured the gantry through which the air subject to the vacuum does not pass. Top plates 524 provides the manifold that supports belts 124 closely adjacent to the opening of the cavity.

FIG. 29 shows the vacuum manifold system 502 as a section view from the end in the YZ plane. When second conduit 506 is in the open position, air is drawn through openings 526 of top plate 524 into a vacuum chamber 530 of cassette 520 and then through an opening 532 in the bottom of vacuum chamber 530 through second opening 518 of vacuum shutoff chamber 514. Air then flows through first opening 516 of vacuum shutoff chamber 514 into first conduit 504 through port 512. Finally, the air exits first conduit 504 through an opening in respective terminal end 508 and flows to the vacuum source either secured to gantry 116 or to a vacuum source spaced from gantry 116 but connected thereto by a flexible hose.

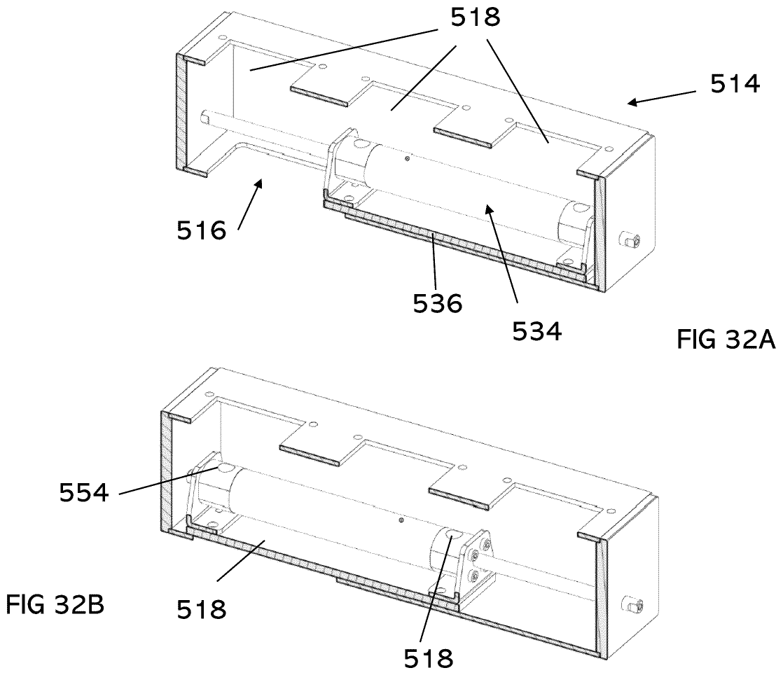

Referring to FIG. 32A vacuum shutoff chamber 514 in an open state. Actuator 534 includes a base member 536 that is moved upon actuation of actuator 534 between a disengaged position such that first opening 516 is in fluid communication with first conduit 504 and an engaged position in which base member 536 covers first opening 516 preventing flow of air from vacuum shutoff chamber 514 to first conduit 504.

Referring to FIG. 32B the vacuum shutoff chamber 514 in a closed state when a port 554 on the shutoff cylinder of actuator 534 so that the shutoff cylinder is moved to a position where base member 536 closes first opening 516, preventing air flow to move through vacuum shutoff chamber 514.

Referring to FIG. 28 terminal end 508 and terminal end 510 are connected with ports that extend through end plates 538 where the air flow through top plate 524 vacuum shutoff chamber 514 and first conduit first conduit 504 is pulled via hoses connected to a regenerative blower. In this manner a vacuum is applied to the material being processed closely adjacent to an opening 556 to cavity 522 causing air to flow along a path 558 into first conduit 504 and to a vacuum source. Opening 556 of cavity 522 is defined as the longitudinal extending opening along the Y-axis (cross table) that extends generally perpendicular to the X-axis of system 110 and the longitudinal axis of belts 124.

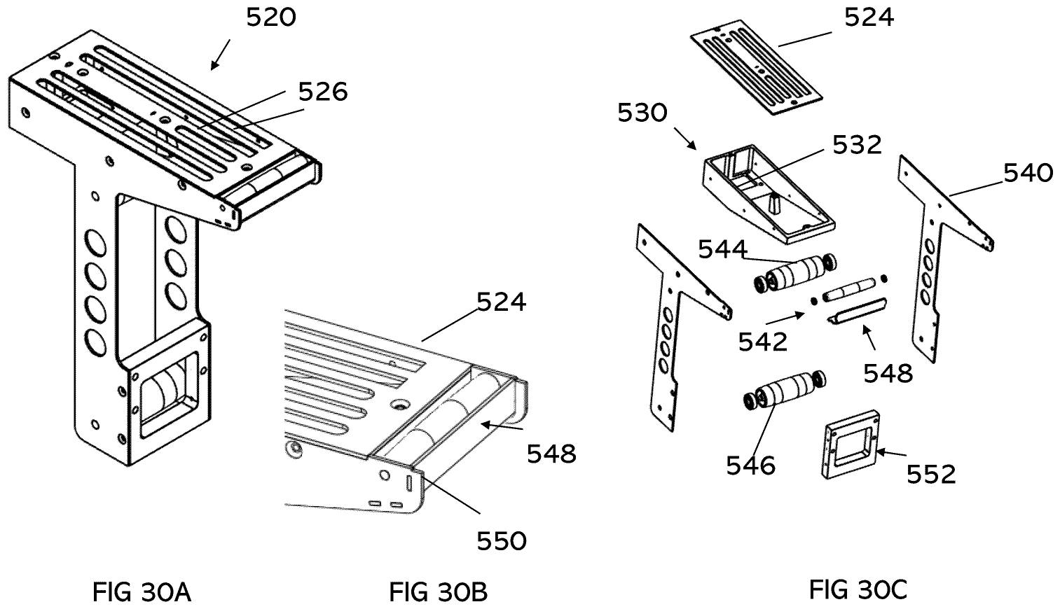

Referring to FIG. 30A, FIG. 30B and FIG. 30C, cassette 520 in one implementation includes a pair of side plates 540 secured to vacuum chamber 530. A first roller 542 is secured to a nose portion of side plates 540. A second roller 544 and a third roller 546 are secured to a longitudinal portion of side plates 540. First roller 542, second roller 544 and third roller 546 direct belt 124 through cassette 520. A nose bar 548 is secured to a front portion of side plates 540 such that belt 124 extends about first roller 542 between vacuum chamber 530 and nose bar 548. Nose bar 548 has an upper edge that is lower than the top surface of top plate 524 such that a ledge 550 is created over which cross belt horizontal belt 126 moves. Ledge 550 ensures that the top of horizontal belt 126 does not extend above belt 124 thereby avoiding movement of the materials being processed by system 110. Nose bar 548 provides a separation between first roller 542 and opening 556 of cavity 522.

A connector 552 is secured to side plates 540 and is connected to a portion of gantry 116 to secure cassette 520 to gantry 116. Referring to FIG. 28 a pair of end plates 538 (only one end plate shown) are secured to gantry 116 to hold first conduit first conduit 504, vacuum shutoff chamber 514.

In one implementation each vacuum shutoff chamber 514 is associated with a second vacuum shutoff chamber 514 positioned on the other side of opening 556 of cavity 522. These two vacuum shutoff chambers 514 act to provide or block a vacuum to the same cassettes 520 and the same belts 124, accordingly, both vacuum shutoff chambers 514 in the matched pair are in a first state to allow vacuum or a second state to block the vacuum from being applied to the fabric above the associated belts 124. In one implementation each of the pair if vacuum shutoff chamber 514 are operated independently to provide a vacuum to belts 124 only on one side of openings 526 of cavity 522.

Referring to FIG. 28 each belt 124 extends over top plate 524 of a first cassette 520 about first roller 542, second roller 544 and third roller 546 in a first cassette then about a bottom roller that is located below a cross bar of gantry 116 then about third roller 546, second roller 544, and first roller 542 of a second cassette located on the other side of opening 556 of cassette 520 then over 524 of the second cassette. In implementation the vacuum applied to first conduit 504, vacuum shutoff chamber 514, and vacuum chamber 530 of cassette 520 is separate from the rest of system 110. As discussed herein belts 124 move about gantry 116 when belts 124 are moved when gantry 116 is stationary with respect to frame 114. Additionally, when belts 124 are stationary with respect to bars 150a, bars 150b, bars 152b and bars 152a a center portion moves about gantry 116 as gantry 116 is moved along longitudinal axis 118 (the X-axis toward and away from first longitudinal end 146 and second longitudinal end 148.

The flow of air caused by the vacuum along path 558 is isolated from other regions of system 110, including but not limited to cavity 522. In one implementation path 558 is hermetically sealed allowing the flow of air only along path 558,

In one implementation system 110 has no separate cross table components extending along the Y-axis separate from the gantry. Belts 124 alone provide support for the materials to be joined by sewing or other joining system and/or cut by a laser or other cutting system. The only additional support secured to and movable with the gantry are the cassettes which have a top plate 524 that supports the belts 124 closely adjacent to opening 556 of cavity 522. First conduit 504 and second conduit 506 extend along the Y-axis and are fixed with respect to and move with gantry 116. The vacuum source is secured to a longitudinal end of first conduit 504 and second conduit 506. A vacuum shutoff chamber 514 is controlled to provide a vacuum to the cassettes that are closely adjacent to the materials being joined and/or cut. In one implementation each cassette has a separate vacuum shutoff chamber 514 that selectively provide a vacuum to the cassette. Referring to FIG. 28, in one implementation each vacuum shutoff chamber 514 selectively provides a vacuum to three cassettes. It is contemplated that each vacuum shutoff chamber 514 selectively provides a vacuum to more than one cassette 520. In one implementation areas vacuum shutoff chamber 514 is in a closed or disengaged position not allowing a vacuum to be transmitted to the cassette 520 in areas where material is not being joined and/or cut by the system. In one implementation, the vacuum is applied only to the underside of the belts 124 closely adjacent to opening 532 of cavity 522 and not to cavity 522 itself.

In one implementation the vacuum source providing the vacuum via cassettes 520 to hold the material against belts 124 is separate from a vacuum source provided to remove fumes associated with laser cutting of the material.

In one implementation a pair of hold down rollers extend across system 110 in the Y direction over top plate 524 to further secure the material being processed (sewn or cut) with respect to cassette 520 and belts 124 to further minimize the vacuum force required to hold down the materials being processed with system 110.

The following is a list of non-limiting illustrative embodiments disclosed herein.

Illustrative embodiment 1. An automated material processing system including: a frame having a longitudinal axis; a gantry movable along the longitudinal axis of the frame; a first belt extending along the longitudinal axis and moving about a cavity having a cavity opening within the gantry; a second belt supported by the gantry extending across the frame in a cross-frame direction perpendicular to the longitudinal axis and covering at least a portion of the cavity opening; a material treatment system to treat a material extending across at least a portion of the first belt and a portion of the second belt; and a vacuum system movable with the gantry and operatively connected to a manifold adjacent to both sides of the cavity opening.

Illustrative embodiment 2. The automated material processing system of illustrative embodiment 1, wherein the material treatment system includes a first portion outside of the cavity and a second portion within the cavity.

Illustrative embodiment 3. The automated material processing system of illustrative embodiments 1-2, wherein the cavity has a rectangular shape with a pair of side walls a base supporting a portion of the material treatment system; and a cavity opening.

Illustrative embodiment 4. The automated material processing system of any one of illustrative embodiments 1-3, wherein a cavity opening adjacent a supporting surface for supporting a material being processed has a cavity opening width that is less than a cavity width between the cavity opening and a cavity base member.

Illustrative embodiment 5. The automated material processing system of any one of illustrative embodiment 1-4, wherein the second belt has a belt path that extends substantially over an entire length of the gantry in a direction perpendicular to the longitudinal axis of the frame; the second belt extending above the cavity about a first pair of rollers on a first side of the frame, below the cavity and below the first belt portion that extends about the cavity, and about a second pair of rollers on a second side of the frame.

Illustrative embodiment 6. The automated material processing system of any one of illustrative embodiments 1-5, wherein the first belt has a belt path about the frame and cavity that extends from a first end of the frame on first longitudinal side of the cavity opening about a first roller adjacent the first longitudinal side of the cavity opening, over a second roller that is closer to a first end of the frame than the first roller, over a third roller that is further from the first roller than the second roller, under the cavity and over a fourth roller positioned further from the first end of the frame than the third roller, over a fifth roller closer to the cavity opening than the fourth roller, over a sixth roller adjacent a second longitudinal side of the cavity opening.

Illustrative embodiment 7. The automated material processing system of any one of illustrative embodiments 1-6, wherein the first belt has a first surface having a first coefficient of friction that supports a material to be treated and a second opposing surface having a second coefficient of friction less than the first coefficient of friction.

Illustrative embodiment 8. The automated material processing system of illustrative embodiment 7, wherein the second belt has a first surface facing the material to be treated having a coefficient of friction that is less than the first coefficient of friction of the first side of the first belt.

Illustrative embodiment 9. The automated material processing system of any one of illustrative embodiments 1-8, wherein the manifold adjacent to both sides of the cavity opening has a plurality of openings facing a material being treated, wherein the manifold provides a vacuum force attracting the material being treated toward the manifold, wherein the manifold extends a predetermined distance away from the cavity opening.

Illustrative embodiment 10. The automated material processing system of illustrative embodiment 9, wherein the cavity is vacuum free.

Illustrative embodiment 11. The automated material processing system of any one of illustrative embodiment 1-10, wherein the vacuum system includes a plurality of pairs of vacuum cassettes operatively connected to a vacuum source.

Illustrative embodiment 12. The automated material processing system of illustrative embodiment 11, wherein each vacuum cassette includes a first region in fluid communication with the vacuum source and a second region including at least two rollers.

Illustrative embodiment 13. The automated material processing system of illustrative embodiment 12, wherein each vacuum cassette includes a top plate having a plurality of apertures therethrough in fluid communication with the first region.

Illustrative embodiment 14. The automated material processing system of any one of illustrative embodiments 1-13, wherein the vacuum system includes a plurality of pairs of vacuum cassettes, wherein one vacuum cassette of each pair of vacuum cassettes includes the first roller, the second roller and the third roller, and the other of the vacuum cassette in each pair of vacuum cassettes includes the fourth roller, the fifth roller and the sixth roller.

Illustrative embodiment 15. The automated material processing system of illustrative embodiment 13, wherein each cassette includes a notch receiving one longitudinal edge of the second belt proximate a bottom side of the second belt, wherein a top side of the second belt that faces the material being treated is parallel with the top plate of the vacuum cassette.

I Illustrative embodiment 16. The automated material processing system of any one of illustrative embodiment 2-15, wherein the material treatment system is a laser system including a laser nozzle located in the first portion and a laser dump device in the second portion within the cavity.

Illustrative embodiment 17. The automated material processing system of illustrative embodiment 16, wherein the laser dump device includes a light sensor detecting laser scattered from a reflecting surface.

Illustrative embodiment 18. The automated material processing system of illustrative embodiment 17, including a controller receiving a signal from the light sensor and providing instructions to the laser nozzle adjusting the laser energy emitted from the laser nozzle as a function of the signal from the light sensor.

Illustrative embodiment 19. The automated material processing system of illustrative embodiment 18, wherein the controller provides instructions to a first actuator driving the gantry along the longitudinal axis of the frame and to a second actuator moving the material treatment system along a longitudinal axis of the gantry.

Illustrative embodiment 20. The automated material processing system of any one of illustrative embodiments 1-19, wherein the material treatment system includes a joining system supported by the gantry and movable along a cross-frame axis perpendicular to the longitudinal axis to join at least two materials together.

Illustrative embodiment 21. The automated material processing system of any one of illustrative embodiments 1-20, wherein the material treatment system includes a cutting system supported by the gantry and movable along the cross-frame axis to cut the material together in more than one direction within a plane defined by the longitudinal axis and the cross-frame axis.

Illustrative embodiment 22. The automated material processing system of any one of illustrative embodiments 2-20, wherein the material treatment system includes a creasing module including a first module positioned outside the cavity a second lower member positioned within the cavity, wherein the first member and the second member are on opposite sides of the material being creased.

Illustrative embodiment 23. The automated material processing system of any one of illustrative embodiments 2-20, wherein the material treatment system includes a grommet insertion module including a first member positioned outside the cavity a second lower member positioned within the cavity, wherein the first member and the second member are on opposite sides of the material which the grommet is being inserted.

Illustrative embodiment 24. The automated material processing system of any one of illustrative embodiments 2-20, wherein the material treatment system includes a button insertion module including a first member positioned outside the cavity a second lower member positioned within the cavity, wherein the first member and the second member are on opposite sides of the material which the button is being attached.

Illustrative embodiment 25. The automated material processing system of any one of illustrative embodiments 2-20, wherein the material treatment system includes a routing tool module including a first member positioned outside the cavity holding a first end of a router bit and a second lower member positioned within the cavity having a member guiding a portion of the router bit within the cavity.

Illustrative embodiment 26. The automated material processing system of any one of illustrative embodiments 2-20, wherein the material treatment system includes an oscillating blade module including a first member positioned outside the cavity driving a first end of the oscillating blade and a second lower member positioned within the cavity having a member guiding a portion of the oscillating blade within the cavity.

Illustrative embodiment 27. An automated system for joining and cutting flexible materials including: a frame having a longitudinal axis; a gantry movable along the longitudinal axis; a belt system extending along the longitudinal axis and moving through a cavity within the gantry; a joining system supported by the gantry and movable along a cross-frame axis perpendicular to the longitudinal axis to join at least two materials together; a cutting system supported by the gantry and movable along the cross-frame axis to cut the material together in more than one direction within a plane defined by the longitudinal axis and the cross-frame axis a vacuum system movable with the gantry and operatively connected to a manifold on both sides of the cavity opening.

Illustrative embodiment 28. An automated system for joining and cutting flexible materials including: a frame having a longitudinal axis; a gantry movable along the longitudinal axis; a vacuum system having a duct movable with and along a cross-frame axis perpendicular to the longitudinal axis of the gantry; a belt system extending along the longitudinal axis and moving through a cavity within the gantry; and a material treatment system movably supported by and along the gantry configured to treat a material supported by the belt system.

Although the present disclosure has been described with reference to example embodiments, workers skilled in the art will recognize that changes may be made in form and detail without departing from the spirit and scope of the defined subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described is manifestly intended to be as broad as possible. For example, unless specifically otherwise noted, the definitions reciting a single particular element also encompass a plurality of such particular elements.

What is claimed is:

1. An automated material processing system comprising:
a frame having a longitudinal axis;
a gantry movable along the longitudinal axis of the frame;
a first belt extending along the longitudinal axis and moving about a cavity having a cavity opening within the gantry;
a second belt supported by the gantry extending across the frame in a cross-frame direction perpendicular to the longitudinal axis and covering at least a portion of the cavity opening;
a material treatment system to treat a material extending across at least a portion of the first belt and a portion of the second belt; and
a vacuum system movable with the gantry and operatively connected to a manifold adjacent to both sides of the cavity opening.

2. The automated material processing system of claim 1, wherein the material treatment system includes a first portion outside of the cavity and a second portion within the cavity.

3. The automated material processing system of claim 1, wherein the cavity has a rectangular shape with a pair of side walls; a base supporting a portion of the material treatment system; and a cavity opening.

4. The automated material processing system of claim 1, wherein the second belt has a belt path that extends substantially over an entire length of the gantry in a direction perpendicular to the longitudinal axis of the frame; the second belt extending above the cavity about a first pair of rollers on a first side of the frame, below the cavity and below the first belt portion that extends about the cavity, and about a second pair of rollers on a second side of the frame.

5. The automated material processing system of claim 1, wherein the first belt has a first surface having a first coefficient of friction that supports a material to be treated and a second opposing surface having a second coefficient of friction less than the first coefficient of friction.

6. The automated material processing system of claim 5, wherein the second belt has a first surface facing the material to be treated having a coefficient of friction that is less than the first coefficient of friction of the first side of the first belt.

7. The automated material processing system of claim 1, wherein the manifold adjacent to both sides of the cavity opening has a plurality of openings facing a material being treated, wherein the manifold provides a vacuum force attracting the material being treated toward the manifold, wherein the manifold extends a predetermined distance away from the cavity opening.

8. The automated material processing system of claim 7, wherein the cavity is vacuum free.

9. The automated material processing system of claim 1, wherein the vacuum system includes a plurality of pairs of vacuum cassettes operatively connected to a vacuum source.

10. The automated material processing system of claim 9, wherein each vacuum cassette includes a first region in fluid communication with the vacuum source and a second region free from the vacuum source including at least two rollers.

11. The automated material processing system of claim 10, wherein each vacuum cassette includes a top plate having a plurality of apertures therethrough in fluid communication with the first region.

12. The automated material processing system of claim 1, wherein the vacuum system includes a plurality of pairs of vacuum cassettes, wherein one vacuum cassette of each pair of vacuum cassettes includes a first roller, a second roller and a third roller, and the other of the vacuum cassette in each pair of vacuum cassettes includes a fourth roller a fifth roller and a sixth roller.

13. The automated material processing system of claim 9, wherein each cassette includes a notch receiving one longitudinal edge of the second belt proximate a bottom side of the second belt, wherein a top side of the second belt that faces the material being treated is parallel with a top plate of the vacuum cassette.

14. The automated material processing system of claim 2, wherein the material treatment system is a laser system including a laser nozzle located in the first portion and a laser dump device in the second portion within the cavity.

15. The automated material processing system of claim 1, wherein the material treatment system includes a joining system supported by the gantry and movable along a cross-frame axis perpendicular to the longitudinal axis to join at least two materials together.

16. The automated material processing system of claim 1, wherein the material treatment system includes a cutting system supported by the gantry and movable along the cross-frame axis to cut the material together in more than one direction within a plane defined by the longitudinal axis and the cross-frame axis.

17. The automated material processing system of claim 9, further including a plurality of actuators to selectively provide and prohibit a vacuum to selective cassettes.

18. The automated material processing system of claim 2, wherein the material treatment system is a laser system including a laser nozzle located in the first portion and a second vacuum source providing a vacuum within the cavity below the laser nozzle, wherein the second vacuum source is separate from the vacuum system movable with the gantry and operatively connected to a manifold adjacent to both sides of the cavity opening.

19. An automated system for joining and cutting flexible materials comprising:
a frame having a longitudinal axis;
a gantry movable along the longitudinal axis;
a belt system extending along the longitudinal axis and moving through a cavity within the gantry;
a joining system supported by the gantry and movable along a cross-frame axis perpendicular to the longitudinal axis to join at least two materials together;
a cutting system supported by the gantry and movable along the cross-frame axis to cut the material together in more than one direction within a plane defined by the longitudinal axis and the cross-frame axis
a vacuum system movable with the gantry and operatively connected to a manifold on both sides of a cavity opening.

20. An automated system for joining and cutting flexible materials comprising:
a frame having a longitudinal axis;
a gantry movable along the longitudinal axis;
a vacuum system having a duct movable with and along a cross-frame axis perpendicular to the longitudinal axis of the gantry;
a belt system extending along the longitudinal axis and moving through a cavity within the gantry; and
a material treatment system movably supported by and along the gantry configured to treat a material supported by the belt system.
